(19) United States
(12) Patent Application Publication
(10) Pub. No.: US 2023/0147412 A1
(43) Pub. Date: May 11, 2023

(54) SYSTEMS AND METHODS FOR AUTHORING IMMERSIVE HAPTIC EXPERIENCE USING SPECTRAL CENTROID

(71) Applicant: Meta Platforms Technologies, LLC, Menlo Park, CA (US)

(72) Inventor: Maximilian WEBER, Berlin (DE)

(21) Appl. No.: 18/153,330

(22) Filed: Jan. 11, 2023

Related U.S. Application Data
(63) Continuation of application No. PCT/EP2021/069371, filed on Jul. 12, 2021.
(60) Provisional application No. 63/050,834, filed on Jul. 12, 2020.

(51) Int. Cl. G08B 6/00; G11B 27/031; G10L 25/18

(52) U.S. Cl. CPC G08B 6/00; G11B 27/031; G10L 25/18; G06F 2203/013

(57) ABSTRACT

Disclosed is a method and system of authoring an audio signal to produce an immersive haptic experience. The method and system preprocesses the audio signal in a preprocessor, which is passed to an audio analysis module. The audio analysis module processes the audio signal for a to produce (a) an array of time amplitude values, and (b) an array of spectral centroid values. In another implementation, the audio analysis module transforms the audio signal using Fourier transformation to produce an array of time amplitude frequency values and an array of spectral centroid values. The array of time amplitude values and the array of spectral centroid values are passed to an authoring tool. A user can modify the array of time amplitude values, the array of timer frequency values and the array of spectral centroid values to adjust the audio signal.

### TECHNICAL FIELD

This application is a continuation of PCT application PCT/EP2021/069371, which was filed on Jul. 12, 2021, and that PCT application claims the benefit of the filing date of U.S. provisional application no. 63/050,834, filed on 12 Jul. 2020, and the disclosures of each of these filings are incorporated herein by reference in their respective entireties.

This disclosure relates to a haptic processing system for generation of haptic data using audio signal analysis. More specifically, the descriptions provided herein relate to analyzing audio signals using the spectral centroid and authoring the audio signal to produce haptic data.

### BACKGROUND

Haptic usually refers to a sense of touch or perception provided to a user as a feedback force or vibration. An electronic computing device with haptic feedback can substantially improve human computer interface. The feedback force provides a sense of perception of touch and feel, which can enhance the user experience. With technological advancement, user interfaces integrated with haptics. The haptic feedback provided by the different types of devices are distinguishable, providing a sense of different feel and touch.

A complex process of filtering, transformation and editing is required to efficiently convert audio signal into haptic data to provide a fulfilling user experience. To provide a fulfilling user experience, the audio signal is converted into haptic data which then can be authored and enhanced. The haptic experience is delivered using haptic actuators such as Linear Resonant Actuators (LRA), Wide Band or High Definition actuators, piezo-electric actuators etc. The delivery of the haptic experience is dependent on the audio to haptic conversion of the signal, the response characteristics of the haptic actuator, device specific data, among other factors. Therefore, a proper matching of actuator type and its response characteristics is required to augment user experience.

US application 20200379570 provides a haptic system and method for defining haptic patterns that include both haptic events and audio events. The haptic pattern can be called by an application programming interface, which has haptic mapping functionality that has a haptic experience mapping functionality that generates a same, or similar, haptic experience on different manufacturers or models of electronic devices having different haptic hardware. The prior art provides a method of mapping haptic functionality on different devices for similar experience. However, the disclosed descriptions do not provide authoring the audio content, instead, certain embodiments provide a haptic pattern that has embedded haptic events within the audio events.

US application 20210181851 relates to an adaptive haptic signal generating device. The adaptive signal generating device includes a frequency analysis unit for converting and analyzing a received audio signal in a frequency domain. A frequency equalizer unit allows the adaptive haptic signal generating device to suppress or amplify a specific frequency/frequencies in the frequency domain. A haptic event extraction unit extracts a haptic event based on the suppressed or amplified frequencies. The device then generates a haptic signal corresponding to the haptic event signal. A control unit counts the occurrence of the extracted haptic event signal for each frequency. It then increases the frequency gain of a frequency that has been generated more than a specific predefined number of times. This provides a method of generating haptic events in the frequency domain but does not provide analysis and authoring of haptic output based at least on device characteristics.

US application 20210110681 provides a method of authoring the audio signal into a haptic signal using a filter bank and harmonic percussive source separation but uses a different approach of time amplitude frequency analysis. In contrast, the current application uses a novel approach of calculating the spectral centroid to author audio signals into haptic output.

U.S. Pat. No. 10,467,870 provides a haptic conversion system that analyzes an audio signal, generates haptic signals based on the analysis of the audio signal. The haptic conversion system then plays the generated haptic signals through one or more actuators to produce haptic effects. The haptic conversion system maps the generated haptic signals to the different actuators based on one or more audio characteristics of the audio signal. This discloses a conversion of an audio signal into a haptic signal but fails to disclose authoring the audio signal based at least on the device parameters.

U.S. Pat. No. 9,448,626 discloses a haptic conversion system that intercepts frames of audio data to convert the frames into a haptic signal and plays the created haptic signal through an actuator to produce haptic effects. The haptic signal is based on a maximum value of each audio data frame. The maximum value defines the magnitude of the haptic signal. The haptic signal is applied to the actuator to generate the one or more haptic effects. Embodiments described herein provide a haptic conversion system but do not disclose authoring of the audio content for an immersive haptic experience.

U.S. Pat. No. 9,092,059 discloses a haptic conversion system that receives multiple audio streams of an audio signal. The haptic conversion system then evaluates each stream to determine if at least one parameter of the one or more parameters indicates that stream is to be converted into a haptic effect. The haptic conversion system then identifies whether one or more streams that include at least one parameter are to be converted into the haptic effect. The haptic conversion system further generates, for the identified streams, a haptic signal based on each corresponding stream and sends, for the identified streams, each haptic signal to an actuator to generate a haptic effect. Certain embodiments described herein do not disclose authoring of the converted haptic data from the audio signal.

All cited prior art fails to disclose the novel and unique features of authoring the haptic output. The method and system disclosed provide for: analysis of the audio signal, conversion of audio signal into haptic output, authoring of the converted audio signal into haptic signal based on device characteristics and the embedded actuator characteristics and transforming the frequency bands into the haptic perceptual bandwidth for an immersive haptic experience.

### SUMMARY

Provided herein is a computer implemented method of editing and transforming an audio signal into a haptic data to provide an immersive haptic experience. The computer implemented method receives the audio signal at a preprocessor module to determine a peak to peak amplitude of the audio signal for an audio frame having a fixed number of sampled audio data. In embodiments, the audio frame may include one or more audio packets. Alternatively, the audio signal may be processed based on a fixed or variable window size comprising audio packets or audio sampled data. The computer implemented method performs a fast Fourier transform to derive the frequency distribution of the preprocessed audio signal. The fast Fourier transform comprises an array of time amplitude values, an array of time frequency values, and an array of time amplitude frequency values. Subsequently, the computer implemented method calculates the weighted average mean of the derived frequency distribution to calculate or derive a spectral centroid of the sampled audio data for a fixed or variable size window. The sampled audio data is then replaced with a new sampled audio data and the spectral centroid is calculated. Thereafter, the computer implemented method calculates a new spectral centroid of the audio signal to produce an array of the spectral centroid. The array of the spectral centroid is provided to a user interface to modify the array of spectral centroid for the immersive haptic experience. Finally, the computer implemented method produces a computer readable file that can be parsed by the resynthesis module on an electronic computing device to provide an immersive haptic experience.

In a variation of this implementation, the array of the spectral centroid values may include an array of time amplitude values and an array of time frequency values, which can be modified using the user interface. The modification of the array of spectral centroid values is based at least on a device specific information and an actuator specific information. In embodiments, the device specific information includes device mass, device type, device operating characteristics and actuator specific characteristics embedded in the device.

The spectral centroid of the preprocessed audio signal is calculated by adding the sum of the spectral energy of each frequency multiplied by the average value of each frequency band over the sum of spectral energy for all the frequency bands.

In another implementation, a computer implemented method of authoring and transforming an audio signal into a haptic output to provide immersive haptic experience comprises the steps of: receiving the audio signal at a preprocessor for a fixed number of audio samples; applying harmonic percussive source separation to pre-processed audio samples, wherein the harmonic percussive source separation comprises a harmonic spectrogram and a percussive spectrogram; calculating an array of time amplitude values and an array of time frequency values for the harmonic spectrogram and the percussive spectrogram; providing the array of the spectral centroid, the array of time amplitude values and the array of time frequency values to a user interface to modify at least one of the array of values of the harmonic spectrogram and/or the percussive spectrogram; transforming authored array of spectral centroid, the array of time amplitude values and the array of time frequency values to fit into a haptic perceptual bandwidth, and creating a computer readable file.

In one variation of this implementation, the harmonic percussive source separation further includes a residual spectrogram, which is obtained by subtracting the harmonic spectrogram and the percussive spectrogram from the transformed harmonic percussive source separation spectrogram.

In one variation of this implementation, the transformation of the authored array of spectral centroid, the array of time amplitude values and the array of time frequency values is based at least on a device specific information and an actuator specific information. In embodiments, the spectral centroid for the harmonic component and the percussive component is calculated by adding the sum of the spectral energy multiplied by the average value of each frequency band over the sum of spectral energy of all the frequency bands.

A haptic authoring system for converting an audio signal into a computer readable haptic file, the computer readable file when executed by a processor causes the haptic processing system to produce an immersive haptic experience on the associated electronic computing device, the haptic authoring system comprising: a preprocessor module configured to an audio analysis module, wherein the audio analysis module receives a preprocessed audio signal and converts the preprocessed audio signal into an array of time amplitude values and an array of time frequency values, and wherein the audio analysis module calculates the spectral centroid of the array of time frequency values; an user interface for modifying the array of time amplitude values, the array of time frequency values and the array of time frequency values; a transformation module for transforming an authored array of time amplitude values, an authored array of time frequency values and an authored array of time frequency values to fit into a haptic perceptual bandwidth, and an aggregation and file management module for converting an array of transformed time amplitude values, an array of transformed time frequency values and an array of transformed time frequency values into the computer readable haptic file.

The audio analysis module calculates the spectral centroid by adding the sum of the spectral energy of each frequency multiplied by the average value of each frequency band over the sum of spectral energy for all the frequency bands.

The transformation module may transform the harmonic spectrogram and the percussive spectrogram based at least on a device specific information, including device mass, device type, device operating characteristics and an actuator specific characteristics embedded in the device.

A haptic authoring system for converting an audio signal into a computer readable haptic file, the computer readable file when executed by a processor causes the haptic authoring system to produce an immersive haptic experience on the associated electronic computing device, the haptic authoring system comprising: a preprocessor module configured to an audio analysis module, wherein the audio analysis module receives a preprocessed audio signal and applies a harmonic percussive source separation to the preprocessed audio signal to determine a harmonic spectrogram and a percussive spectrogram, and wherein the audio analysis module calculates the spectral centroid of the harmonic spectrogram and the percussive spectrogram; an user interface for modifying the harmonic spectrogram and the percussive spectrogram, wherein the harmonic spectrogram comprises an array of time amplitude values and an array of time frequency values and the percussive spectrogram comprises an array of time frequency values and an array of impulse sequence; a transformation module for transforming an authored harmonic spectrogram and an authored percussive spectrogram to fit into a haptic perceptual bandwidth, and an aggregation and file management module for converting a transformed harmonic spectrogram and a transformed percussive spectrogram into the computer readable haptic file.

The haptic authoring system includes the audio analysis module, which calculates the spectral centroid by adding the sum of the spectral energy of each frequency multiplied by the average value of each frequency band over the sum of spectral energy for all the frequency bands.

The transformation module of the haptic authoring system transforms the harmonic spectrogram and the percussive spectrogram based at least on device specific information, including device mass, device type, device operating characteristics and actuator specific characteristics embedded in the device.

Disclosed is a method and system of authoring an audio signal to produce an immersive haptic experience. The method preprocesses the audio signal in a preprocessor module. The preprocessed signal is passed to an audio analysis module. The audio analysis module processes the preprocessed audio signal for a fixed time to produce (a) an array of time amplitude values, and (b) an array of spectral centroid (i.e. frequency) values. To produce the array of time amplitude values, the preprocessed audio signal is also passed to an envelope approximation and smoothing module to (a) approximate the preprocessed audio signal into time amplitude values, and (b) smoothen the approximated time amplitude values. The array of time amplitude values is passed to a breakpoint reduction module. The breakpoint reduction module reduces the array of time amplitude values based on a linear approximation of a time sequence. The preprocessed audio signal is also passed to a DC Offset module. The purpose of the DC offset module is to add a small value offset to avoid spectral centroid from rising spuriously during segments, where the audio signal is silent. During absolute or near silence, the audio signal has small amplitude values, which allows high frequencies to dominate during silence. The presence of high frequencies is nor desirable in audio segments of silence. The output of the DC offset is provided to the central tracker module, which calculates the spectral centroid of the audio signal or segments of the audio signal processed in a specific window or a block of audio packets. The spectral centroid is the centre of mass of the block-wise Fourier transformed power spectrum of the audio signal, which provides the dominant frequency of the audio signal for each windowed signal block processed this way. By identifying the dominant frequency for each point in time (i.e. each frame comprising audio data blocks or each window of audio data), the oscillator driving a haptic actuator can be tuned to the spectral centroid value at each point in time, providing a good haptic experience. The novel and unique technique of the spectral centroid tracking is synchronized with the amplitude tracking to provide a better haptic experience.

In some embodiments, other statistics may be utilized such as a spectral bandwidth, a spectral skewness, a spectral flatness, spectral kurtosis, a spectral contrast and a spectral roll-off.

In some embodiments, the time amplitude values are arrays of time amplitude values for different frequency bands.

In parallel, the spectral centroid is calculated from the same preprocessed audio signal for which the time-amplitude values were derived. The preprocessed audio signal is passed into a Fast Fourier Transform to convert the time-domain signal into a frequency domain signal. In some embodiments, the Short Time Fourier Transform may be performed to convert the time domain audio signal into a frequency domain signal.

For a fixed time, a particular number of samples are calculated. The spectral centroid of this particular number of samples is calculated by using a weighted average method. The average frequency of each frequency interval is calculated; the average frequency is multiplied by the spectral energy of that frequency interval to calculate the spectral energy distribution for that frequency band. Similarly, the spectral energy distribution for all frequency bands is calculated. The energy frequency distribution of all the frequency bands is divided by the sum of the average frequency of all the frequency bands to arrive at the spectral centroid. To calculate the array of spectral centroid values, a fixed number of samples are removed and an equal number of samples are added. For example if the buffer size of the frame of the preprocessed audio signal is 1024 samples, each iteration may replace 128 samples and introduce 128 new samples. In this example, the array of spectral centroid values may be obtained.

In some embodiments, the iteration is performed for the same and fixed number of samples for calculating the time amplitude values and spectral centroid values.

In some embodiments, the iteration is performed for the same and fixed number of audio frames for calculating the time amplitude values and the spectral centroid values.

In some embodiments, the iteration is performed for the same and fixed window size for calculating the time amplitude values and the spectral centroid values.

The array of time amplitude values and the array of spectral centroid values are passed to a user interface of the authoring tool for editing and/or modifying and/or appending the array of time amplitude values and the array of spectral centroid values. The transformation module receives the authored array of time amplitude values, the authored array of time amplitude values and the authored array of the spectral centroid values to determine if the authored array of time amplitude values, the authored array of time amplitude values and the authored array of the spectral centroid values can fit within a haptic perceptual bandwidth for each frequency bands. The haptic perceptual bandwidth is the range of frequencies that are above which an actuator embedded in an electronic computing device can reproduce the haptic experience that can be experienced by humans. If the authored array of time amplitude values, the authored array of time amplitude values and the authored array of the spectral centroid values can fit within a haptic perceptual bandwidth for each of the frequency bands, then the authored array of time amplitude values, the authored array of time amplitude values and the authored array of the spectral centroid values is passed to an aggregation and file management module. Otherwise, the authored array of time amplitude values, the authored array of time amplitude values and the authored array of the spectral centroid values are transformed into a transformed array of time amplitude values, a transformed array of time frequency values and a transformed array of the spectral centroid values by implementing a computer implemented algorithm. The computer implemented algorithm performs steps: determining the rank of each frequency band as provided in the user interface. Alternatively, the computer implemented algorithm may calculate the rank of each frequency band based on the spectral energy of each frequency band and its distance from the combined resonant frequency of the electronic computing device having an embedded actuator. Subsequently, the computer implemented algorithm may shift each frequency band and eliminate some of the frequency bands that cannot fit as defined in the algorithm. The transformed array of time amplitude values, the transformed array of time frequency values, and the transformed array of the spectral centroid values are passed to an aggregation and file management module, which converts the transformed array of time amplitude values, the transformed array of time frequency values, and the transformed array of spectral centroid values into a computer readable file format.

Subsequently, the transformed array of time amplitude values, the transformed array of time frequency values, and the transformed array of spectral centroid values are saved in a computer readable haptic file that can be parsed and processed by the resynthesis module.

In some embodiments, the transformed array of time amplitude values, the transformed array of time frequency values, and the transformed array of spectral centroid values are directly passed to the resynthesis module for generating haptic output.

In some embodiments, the processing of authoring the array of time amplitude values, the array of time frequency values, and the array of spectral centroid values happen in real time by applying the deep learning algorithm.

The resynthesis module uses the transformed array of time amplitude values, the transformed array of time frequency values, and the transformed array of spectral centroid values to generate haptic output in one or more actuators. In one variation of this implementation, the transformed array of time amplitude values are used to set the amplitude of one or more actuators and the transformed array of spectral centroid values are used to set the center frequency of the one or more actuators for providing an immersive haptic experience.

In one embodiment, the preprocessed audio signal may be passed to a filter bank. The filter bank may separate the audio signal into different frequency bands and process each frequency band to produce an array of time amplitude values, an array of time frequency values, and an array of spectral centroid values.

In another embodiment, the preprocessed audio signal may be processed separately using a Harmonic Percussive Source Separation (HPSS) module to produce a harmonic spectrogram, a percussive spectrogram, and a residual spectrogram. The harmonic module produces a harmonic spectrogram, Likewise, the percussive module produces the percussive spectrogram and the residual module produces a residual spectrogram. The HPSS module may perform the Fast Fourier Transform (FFT) or the Short Time Fast Transform (STFT) of the received preprocessed audio signal to convert the time domain signal to the frequency domain signal. The FFT or STFT produces the power spectrogram ,which is utilized to produce the harmonic spectrogram and the percussive spectrogram. The harmonic module creates a harmonic spectrogram by median filtering. Likewise, the percussive spectrogram is obtained by filtering the power spectrogram. The audio signal received after filtering from the percussive module is passed to the centroid tracker to calculate the spectral centroid of the percussive spectrogram. The spectral centroid is passed to the envelope approximation and smoothing module. The spectral centroid provides the measure of the main or the dominant frequency of the audio signal.

In embodiments, the spectral centroid may be calculated for a recursively fixed number of audio samples resulting in the array of spectral centroid values for a fixed time.

To produce an array of time amplitude frequency values, the harmonic spectrogram is passed to an envelope approximation and smoothing module to (a) approximate the preprocessed audio signal into an time amplitude frequency values, and (b) smoothen the approximated the time amplitude frequency values. The array of time amplitude frequency values is then passed to a breakpoint reduction module. The breakpoint reduction module reduces the array of time amplitude frequency values based on a linear approximation of a time sequence. Finally, the array of time amplitude frequency values is passed to the amplitude envelope module for extracting an array of time amplitude values from the harmonic spectrogram.

The harmonic spectrogram is also passed to an centroid tracker for calculating the spectral centroid of the array of time amplitude frequency values, Subsequently, the spectral centroid values are passed to an envelope approximation and smoothing module to (a) approximate the preprocessed audio signal into an time amplitude frequency values, and (b) smoothen the time amplitude frequency values. The array of time amplitude frequency values is then passed to a breakpoint reduction module. The breakpoint reduction module reduces the array of time amplitude frequency values based on a linear approximation of a time sequence. Finally, the array of time amplitude frequency values is passed to the frequency envelope module for extracting an array of time frequency values, an array of time amplitude values, and an array of spectral centroid values for the harmonic spectrogram.

The power spectrogram is passed to the percussive module that extracts the percussive spectrogram by filtering. The percussive spectrogram comprises time amplitude frequency values. The percussive spectrogram is then passed to a centroid tracker, which calculates the array of spectral centroid of the audio signal. To produce an array of time amplitude values, the array of spectral centroid values are passed to an envelope approximation and smoothing module to (a) approximate the preprocessed audio signal into an time amplitude values, and (b) smoothen the approximated time amplitude values. The array of time amplitude values is then passed to a breakpoint reduction module. The breakpoint reduction module reduces the array of amplitude time values based on a linear approximation of a time sequence. Finally, the array of time amplitude time is passed to an amplitude envelope module for extracting a reduced array of time amplitude values. Simultaneously, the percussive module passes the percussive spectrogram to the transient module. The transient module detects the presence of transients in the percussive spectrogram and passes the transients to an impulse sequence module to create an array of impulse sequences.

In some embodiments, the transients detected may comprise one or more impulses. The one or more impulses may form the array of impulse sequences, which comprise an array of time amplitude values and/or an array of time frequency files.

The residual module processes the residual spectrogram. The residual spectrogram is passed to an envelope approximation and smoothing module to (a) approximate the preprocessed audio signal into an array of time amplitude frequency values, and (b) smoothen the approximated signal into an array of time amplitude frequency values. The array of time amplitude frequency values is then passed to a breakpoint reduction module. The breakpoint reduction module reduces the array of time amplitude frequency values based on a linear approximation of a time sequence. Finally, the array of time amplitude frequency values is passed to an amplitude envelope module for extracting an array of amplitude time values from the residual spectrogram.

In some embodiments, the spectral centroid of the received audio signal may be calculated for a predefined number of samples over a fixed time or for a fixed number of samples.

The time domain signal is converted into the frequency domain signal by implementing a Fast Fourier Transform (FFT) or a Short Time Fourier Transform (STFT) before performing the spectral centroid calculations. To calculate the spectral centroid of the preprocessed audio signal, the frequency spectrum is analyzed, for each frequency band, the average frequency is calculated, the average frequency of each band is multiplied by the spectral energy of that frequency band. The sum of product of average frequency and spectral energy of all frequency bands is calculated, which is divided by the sum of spectral energy of all frequency bands. After calculating the spectral centroid, the audio samples are left shifted, that is, removing the last predefined number of samples and replacing them with the same number of new audio samples. In this way an array of spectral centroid values is produced, which are provided to the authoring tool for editing and/or modifying the array of spectral centroid values.

The array of time amplitude values and the array of impulse sequences obtained by analysis of transients from the percussive spectrogram is provided to an impulse processing module. In addition, the impulse processing module also receives the array of time amplitude values and the array of time frequency values from the harmonic spectrogram. Additionally, the array of time amplitude frequency values from the residual module is also passed to an authoring tool for modifying/editing/appending the analyzed audio signal.

In some embodiments, the residual module is optional and only the harmonic module and the percussive module are used for analysis. The array of time amplitude values and the array of impulse sequences received from the percussive module; the array of time amplitude values and the array of time frequency values received from the harmonic module may be provided to an impulse processing module.

In some embodiments, the time amplitude frequency values from the residual module may be passed to the impulse processing module along with the audio signal from the harmonic module and the percussive module.

In some embodiments, the time amplitude frequency values from the residual module may be passed directly to the authoring tool.

The authoring tool includes a Graphical User Interface (GUI) to edit and/or modify and/or append the array of time amplitude values and the array of impulse sequences from the impulse sequence of the percussive module. In addition, the GUI also receives the array of time amplitude values and the array of time frequency values from the harmonic module. Further, the array of time amplitude frequency values from the residual module are also provided to the GUI editor.

In some embodiments, no modification is performed by the user through GUI to the arrays of time amplitude values, the array of impulse sequence from the percussive module and the array of time amplitude values and the array of time frequency values of the harmonic module. In this embodiment, no authoring of the analyzed audio signal received from the audio analysis module is required. In an alternate embodiment, the authoring of the analyzed audio signal received from the audio analysis module is performed automatically using deep learning algorithms. The trained deep learning algorithm continuously learns from ongoing data analysis.

In some embodiments, the authoring tool may be bypassed and no authoring of the analyzed audio signal may be performed. In some embodiments, the residual module may be ab sent.

The transformation module receives an authored array of time frequency values and an authored array of time amplitude values from the continuous stream; an authored array of time amplitude values and an authored array of impulse sequence from the impulse stream to determine if the authored array of time amplitude; the authored array of impulse sequence; the authored array of time frequency values; the authored array of time amplitude frequency values received from the continuous stream, the impulse stream, and the residual module (optional) can fit within a haptic perceptual bandwidth for each of the frequency bands. If the authored array of time amplitude; the authored array of impulse sequence; the authored array of frequency time values; the authored array of time amplitude frequency values from the continuous stream and the impulse stream can fit within a haptic perceptual bandwidth for each of the frequency bands, then the these authored array of values are passed to an aggregation and file management module. Otherwise, the authored array of time amplitude; the authored array of impulse sequence; the authored array of frequency time values; the authored array of amplitude frequency values is transformed into a transformed continuous stream and a transformed impulse stream by implementing an algorithm. The algorithm performs steps determining the rank of each of frequency bands or calculating the rank of each of frequency bands, shifting of frequency bands, and eliminating some of the frequency bands as per the implemented algorithm. The transformed array of time amplitude frequency values is passed to an aggregation and file management module, which converts the transformed array of values into a computer readable file format. Finally, the computer readable file format can be parsed by a resynthesis module having a synthesizer to generate a haptic output.

In some embodiments, the comparator uses statistical analysis and weighting to make informed decisions on the two streams of impulses, that is, the harmonic stream and the percussive stream to remove duplicates and/or overlaps.

In some embodiments, the comparator may use analytics and machine learning to predict and/or merge or remove duplicates during merging of the harmonic stream and the percussive stream.

In some embodiments, the slope of the impulse events generated from the harmonic spectrogram is utilized for generating and/or marking the impulse events. The slope calculated from the harmonic spectrogram is compared with a threshold value of the slope. If the gradient of the slope is greater than the threshold value then an impulse event is generated.

In some embodiments, the sharpness value is also recorded by measuring the slope steepness/gradient. The sharpness value is passed into the comparator.

In some embodiments, the impulse events generated from the percussive component are detected by the transient detector by comparing the values of a fast envelope follower and the slow envelope follower.

In some embodiments, the impulse events are generated from the percussive component using the transient detection algorithm. The impulse events are also generated in parallel by the harmonic component. In some embodiments, the comparator receives two sets of impulse signals (a) processed from the harmonic spectrogram and (b) processed from the percussive spectrogram are merged to form one impulse sequence.

In some embodiments, the output of the comparator with merged impulse events from the harmonic stream and the percussive stream are analyzed, the overlaps merged intelligently, and then ducking off the continuous envelope when an impulse event occurs.

In some embodiments, the merged impulse events may be directly provided to the transformation module and to the mixer for providing haptic experience.

In some embodiments, the merged impulse events may be provided to the authoring tool for editing and or modification before passing it to the transformation module and to the mixer for providing haptic experience.

In some embodiments, the user interface editor associated with the authoring tool 208 may receive an array of time-frequency values or the frequency envelope of the audio signal.

In one embodiment, the frequency envelope may be obtained by a spectral centroid. In another embodiment, the frequency envelope may be obtained from the percussive spectrogram and/or the harmonic spectrogram.

The frequency envelope generated by the spectral centroid is smoothed and breakpoint-reduced to reduce the frequency envelope. The frequency envelope is then passed out the user interface, for example, the user interface. The user interface displays the frequency envelope together with the amplitude envelope for the same set of audio samples or audio signals. In some embodiments, the user can view and adjust the frequency envelope values. In addition, the user can also edit the amplitude envelope values. The user interface associated with the authoring tool provides a novel method of dealing with audio silence.

### BRIEF DESCRIPTION OF THE DRAWINGS

FIG. 1 illustrates an overview of an operating environment of a haptic processing system in an embodiment;

FIG. 2 illustrates different modules of a haptic module in the embodiment;

FIG. 3 illustrates a haptic module operating in a distributed environment in another embodiment;

FIG. 4A illustrates the block diagram of an audio analysis module implementing a spectral centroid for converting an audio signal into a haptic output in an embodiment;

FIG. 4B illustrates the block diagram of an audio analysis module implementing a filter banks for converting an audio signal into a haptic output in another embodiment;

FIG. 5A illustrates the block diagram of an audio analysis module implementing a harmonic-percussive source separation for converting an audio signal into a haptic output in an embodiment;

FIG. 5B illustrates the block diagram of an audio analysis module implementing a harmonic-percussive source separation for converting an audio signal into a haptic output in another embodiment;

FIG. 5C illustrates the block diagram of the impulse processing module in an embodiment;

FIG. 5D illustrates the block diagram of an authoring tool for processing audio data in an embodiment;

FIG. 6 illustrates the block diagram of processing of haptic output for producing haptic experience in an embodiment;

FIG. 7 illustrates the block diagram of processing of the in another embodiment;

FIG. 8A illustrates the method of detecting an impulse in an audio stream using gradient approach in the embodiment;

FIG. 8B illustrates the method of merging the impulse in different audio signals using gradient approach in the embodiment;

FIG. 9 illustrates a graphical user interface of an authoring tool in the embodiment;

FIG. 10 illustrates a block diagram of a transformation module in the embodiment;

FIG. 11 illustrates an aggregation and file management module in the embodiment;

FIG. 12 illustrates a resynthesis module in the embodiment;

FIG. 13 illustrates the process of handling an audio signal having audio silence in an embodiment;

FIG. 14 illustrates a process of converting an audio signal into a computer readable haptic file in an embodiment;

FIG. 15 illustrates a process of implementing a filterbank analysis to an audio signal in an embodiment; and

FIG. 16 illustrates a process of implementing a harmonic percussive source separation analysis to an audio signal in an embodiment.

### DETAILED DESCRIPTION

As used herein, the term “input audio signal”, “received signal”, “processed signal”, “audio signal” are intended to broadly encompass all types of audio signal including analog audio signal, digital audio signal, digital audio data, audio signal embedded in media programs including signal embedded in video or audio that can be rendered using a rendering device capable of reproducing any other type of audio or media program connected to a network or any electronic device operating independently. It also encompasses live media, linear media and interactive media programs such as music, games, online video games or any other type of streamed media program with embedded audio. Furthermore, these terms also include an array of time amplitude values, an array of time frequency values, an array of time amplitude frequency values, an array of impulse sequence values to substantiate the contextual meaning at different places.

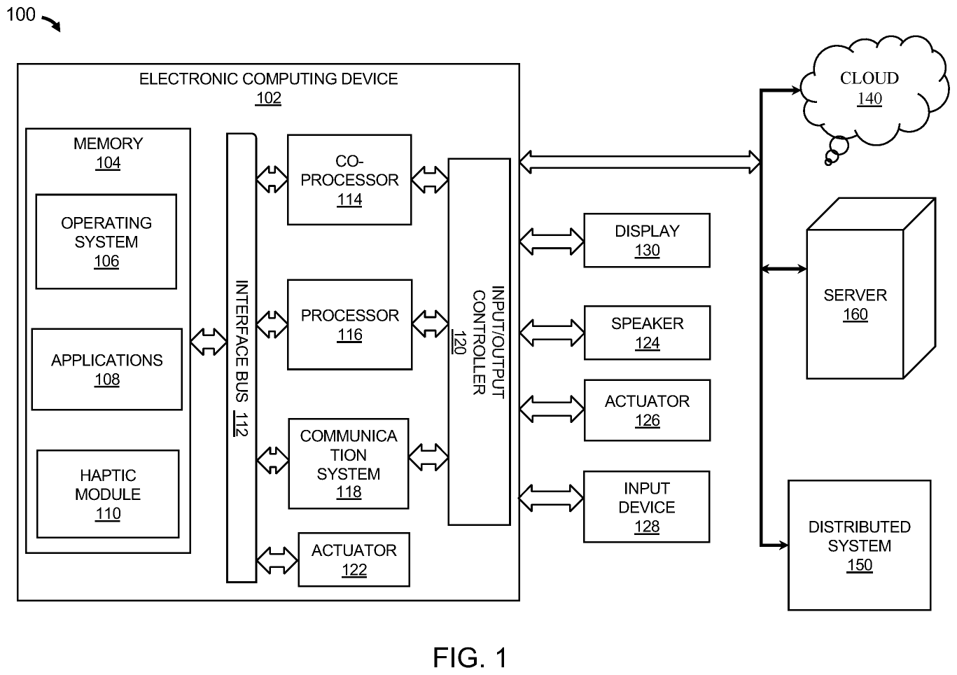

FIG. 1 illustrates an overview of an operating environment of a haptic processing system in an embodiment. The operating environment of a haptic processing system 100, an electronic computing device 102 connected to a cloud 140, a server 160, and a distributed system 150 via wired or wireless network . The operating environment 100 is exemplary and other variations may include different implementations with fewer or additional things.

The electronic computing device 102 includes a memory 104, a coprocessor 114, at least one processor 116, a communication system 118, an interface bus 112, an input/output controller 120, and one or more actuators 122. In addition, one or more haptic actuators 126 may be associated with the electronic computing device 102. For example, a haptic actuator such as the actuator 126 may be embedded in a haptic vest directly associated with the electronic computing device 102. An interface bus 112 provides power and data communication to the memory 104, the processor 116, the coprocessor 114, the input/output controller 120 (also referred to as I/O 120), the communication system 118 and one or more actuators 122. The I/O controller 120 is connected with other devices such as a display 130, at least one speaker 124, at least one actuator 126, and at least one input device 128 such as a keyboard, a mouse, a gamepad, a joystick, a touch panel, or a microphone. In some embodiments, the one or more actuators 126 may be embedded in one or more input device 128, for example, a keyboard, a mouse, a gamepad, a joystick, a touch panel, or a microphone. Alternatively, the one or more actuators 126 may be directly interfaced with the electronic computing device 102.

The I/O controller 120 provides power, control information, and enables data communication between the display 130, the speaker 124, the actuator 126, and the input device 128. Alternatively, the display 130, the speaker 124, the actuator 126, and the input device 128 can self power by a battery or a regulated power supply. In addition, the I/O controller 120 may provide data communication to these devices through a wired or a wireless connection.

The memory 104 comprises an operating system 106, one or more applications 108, and a haptic module 110. The haptic module 110 includes computer executable instructions to produce a haptic signal from an audio signal for providing an immersive haptic experience. The haptic module 110 exchanges data and information with other components/devices such as one or more actuators 122 and/or the one or more actuators 126. Additionally, the haptic module 110 can communicate with the cloud 140, the server 160, the distributed system 150 through the communication system 118.

The memory 104 can be a Read-Only Memory (ROM), Random-Access Memory (RAM), digital storage, magnetic tape storage, flash storage, solid-state device storage or some other type of storage device. The memory 104 can store encrypted instructions, source code, binary code, object code, encrypted compiled code, encoded executable code, executable instructions, assembly language code or some other type of computer readable instructions.

In some embodiments, the haptic module 110 can be implemented as a separate module having a dedicated processor and memory. For example, the haptic module 110 may be a SoC or implemented in memory 104 associated with a microcontroller.

The processor 116 and the coprocessor 118 are enabled to provide hyper-threading, multi-tasking, and multi-processing. Alternatively, the processor 116 can be a special purpose processor or some other type of microprocessor capable of processing analog or digitalized audio signals. The processor 116 and the coprocessor 118 can implement special hardware that is designed for digital signal processing, for example, MMX technology provided by Intel®. MMX technology provides an additional instruction set to manipulate audio, video, and multimedia. The processor 116 can any type of processor such as MMX, SSE, SSE2 (Streaming SIMD Extensions 2), SSE3 (Streaming SIMD Extensions 3), SSSE3 (Supplemental Streaming SIMD Extensions 3), SSE4 (Streaming SIMD Extensions 4) including the variants SSE 4.1 and SSE4.2, AVX (Advanced Vector Extensions), AVX2 (Haswell New Instructions), FMA (Fused multiply—add) including FMA3, SGX (Software Guard Extensions), MPX (Memory Protection Extensions), Enhanced Intel SpeedStep Technology (EIST), Intel® 64, XD bit (an NX bit implementation), Intel® VT-x, Intel® VT-d, Turbo Boost, Hyper-threading, AES-NI, Intel® TSX-NI, Intel® vPro, Intel® TXT, Smart Cache or some other type of implementation for a processor. The processor 116 or the coprocessor 118 can be a soft processor such as the Xilinx MicroBlaze® processor that can include at least one microcontroller, real-time processor, an application processor and the like.

The communication system 118 can interface with external devices/applications via wired or wireless communication. For example, the communication system 118 can connect to a server 160 via a wired cable. The communication system 118 has an encoder, a decoder, and provides a standard interface for connecting to a wired and/or wireless network. Examples of communication interfaces include, but are not limited to, Ethernet RJ-45 interface, thin coaxial cable BNC interface and thick coaxial AUI interface, FDDI interface, ATM interface and other network interfaces.

The cloud computing environment on the cloud 140 may include computing resources and storage. The storage may include one or more databases with at least one database having information about different actuators, devices in which actuators are embedded or associated, haptic hardware, haptic game specific data, haptic preferences of users, and content information such as gaming information including game type.

The server 160 is multi-processor, multi-threaded, with a repository comprising databases, which includes one or more databases having actuator specific information, device specific information, and content information for example computer games including the type of game. The distributed system 160 includes distributed databases that hold information about actuator specific information, device specific information, and content information such as computer games and the different attributes of the games like type, number of players, etc.

In some embodiments, the actuator specific information is related to the specification data of the actuator. Similarly, the device specific information may be related to specification data of the electronic computing device 102 in which the actuator is embedded. In some embodiments, the manufacturer of the actuator and the electronic computing device 102 may be different. Therefore, the specification of both the electronic computing device 102 and the actuator are required, even though the actuator is embedded in the electronic computing device 102. In preferred embodiments, the device specific information includes the device specification along with the actuator specific information, which is embedded in the device.

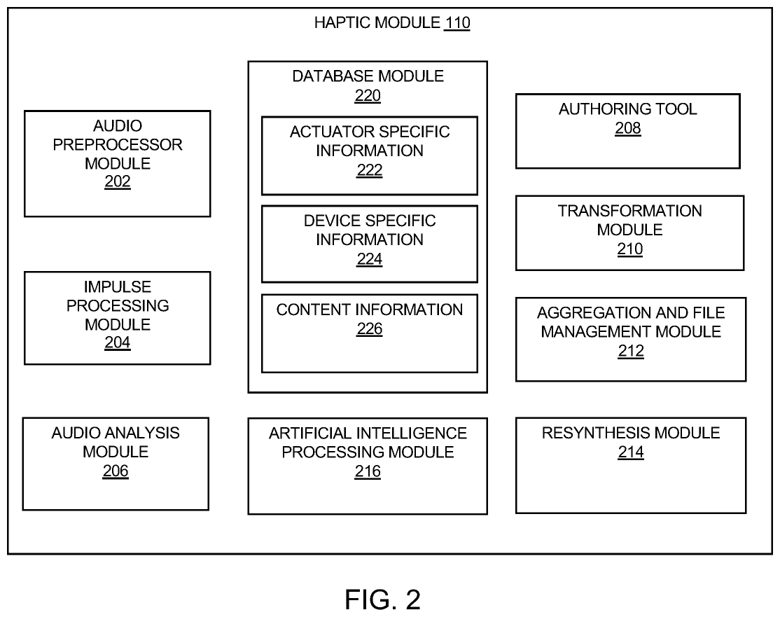

FIG. 2 illustrates different parts of a haptic module in an embodiment. The haptic module 110 includes an audio preprocessor module 202, an impulse processing module 204, an audio analysis module 206, an authoring tool 208, a transformation module 210, an aggregation and file management module 212, a resynthesis module 214 an artificial intelligence processing module 216, and a database module 220.

In preferred embodiments, the haptic module 110 is stored in the memory 104 of the electronic computing device 102, which can be a desktop computer, a laptop, a gaming console, a mobile computing device such as a phone or a tablet, a gaming controller such as a joystick, gamepad, flight yoke, gaming mouse, gaming keyboard, keyboard wrist rest, mouse pad, headphones, a virtual computing environment, an electronic gaming composer, a gaming editing application running on a server or a cloud or some other computing device. In some embodiments, the resynthesis module 214 may be implemented separately in different devices, which can process the haptic file to produce an immersive haptic experience.

In another variation of the implementation, the resynthesis module 214 includes a synthesizer for generating a haptic output by parsing a computer readable file. The resynthesis module 214 may include one or more actuators connected either directly or through a mixer, which mixes an array of amplitude time values and an array of frequency time values to drive one or more actuators to provide an immersive haptic experience.

In some embodiments, the cloud 140, the server 160, the distributed system 150 may allow one or more game developers to use authoring tools concurrently, share information, share feedback, and communicate with each other for authoring games.

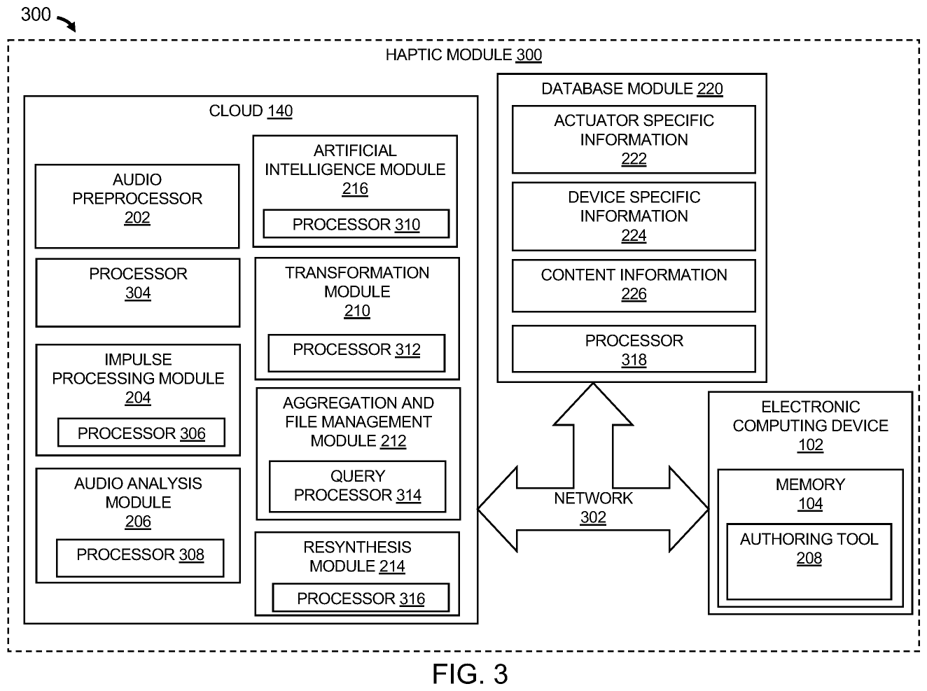

FIG. 3 illustrates the different modules of a haptic module implemented in distributed environments in an embodiment. The haptic module 300 may reside on the cloud 140 or the server 160 or over the distributed system 150.

FIG. 3 shows only one implementation of the haptic module 300 with different modules distributed over the network and residing in different devices, however, there can be other implementations of the haptic module 300 having fewer or more modules residing over a network on different devices. For example, in one implementation, the audio preprocessor module 202, the impulse processing module 204, the audio analysis module 206, the artificial intelligence module 216, the transformation module 210, the aggregation and file management module 212, and the resynthesis module 214 all reside on the cloud 140. The database module 220 has a processor 318 and associated memory and resides as a distributed database over a network 302. The electronic computing device 102 includes the authoring tool 208 for analyzing the audio signal and authoring haptic events.

Each module has a dedicated processor and memory. In different implementations, different modules may be distributed over the network 302, For example, the audio preprocessor module 202 has a processor 304, the impulse processing module 204 has a processor 306, the audio analysis module 206 has a processor 308, the artificial intelligence module 216 has a processor 310, the transformation module 210 has a processor 312, the aggregation and file management module 212 has a processor 314, and the resynthesis module 214 has a processor 316, and the authoring tool 208 can also have a processor, if the authoring tool resides outside the electronic computing device 102.

By way of example and not a limitation, in another variation of this implementation, the audio preprocessor module 202, the impulse processing module 204, the audio analysis module 206, the artificial intelligence module 216, the transformation module 210, the aggregation and file management module 212, the resynthesis module 214, and the authoring tool 208 reside on the server 160. The database module 220 can be a distributed database or a network implemented database residing over the network 302.

Other variations and permutations are also possible for deploying different modules on different devices distributed over the network 302. For example, the audio preprocessor module 202, the impulse processing module 204, the audio analysis module 206, the artificial intelligence module 216, the transformation module 210, the aggregation and file management module 212, the resynthesis module 214, the authoring tool 208, and the database module 220 are also possible.

FIG. 3 is an exemplary illustration and should not be construed as limiting for the implementation of the haptic module 300 over the network 302.

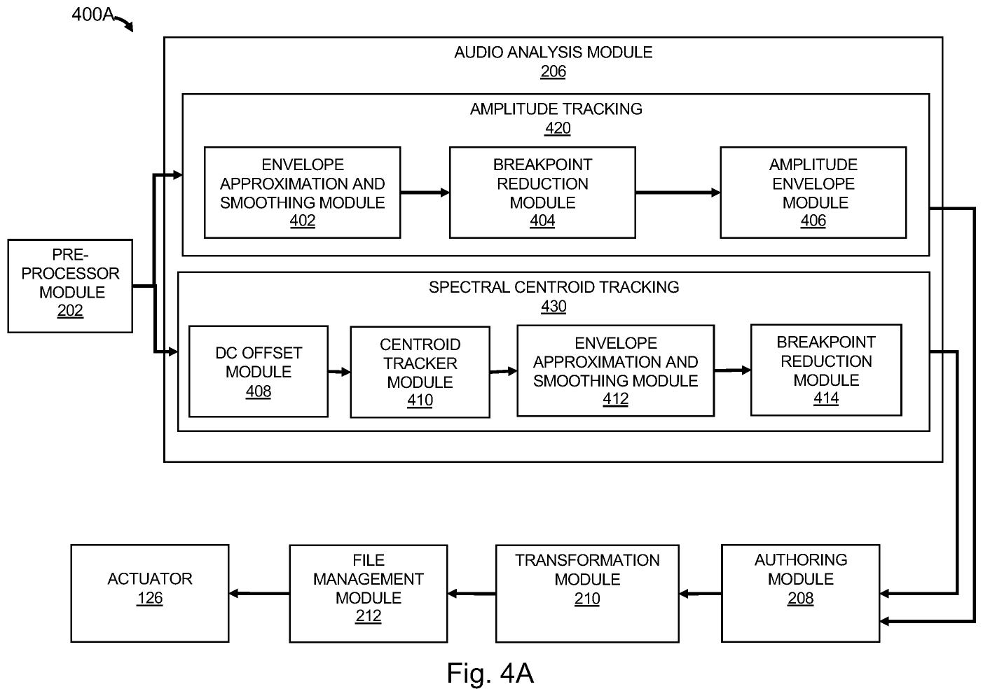

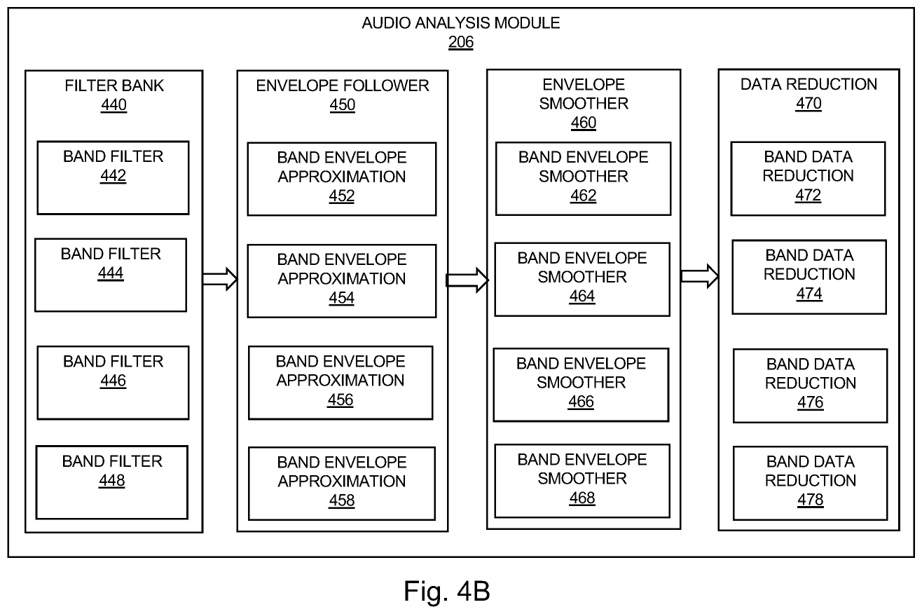

FIG. 4A illustrates different components of an audio analysis module for converting the audio signals into a haptic signal in an embodiment. The haptic processing module 400A receives the audio signal at the pre-processor module 202. The preprocessor module 202 removes unwanted frequencies, distortion and other non-linear characteristics from the audio signal. The preprocessed audio signal is passed to the audio analysis module 206 for further processing of the audio signal. The audio analysis module 206 processes the preprocessed audio signal for a fixed time to produce an array of time amplitude values and an array of spectral centroid values.

In some embodiments, the audio analysis module 206 processes the preprocessed audio signal for a fixed window. In another embodiment, the audio analysis module 206 processes the preprocessed audio signal for a fixed number of frames. In yet another embodiment, the audio analysis module 206 processes the preprocessed audio signal for a fixed number of audio samples.

To produce the array of time amplitude values, the preprocessed audio signal is passed to an envelope approximation and smoothing module 402 to approximate the preprocessed audio signal into time amplitude values, and to smoothen the time amplitude values. The array of time amplitude values is passed to a breakpoint reduction module 404. The breakpoint reduction module 404 reduces the array of time amplitude values into a linear approximation of a time sequence. Finally, an amplitude envelope module 406 produces an envelope of the linear approximated time sequence and then passes the array of amplitude time values to the authoring tool 208. In some embodiments, the array of time amplitude values received from the amplitude envelope 406 are for different frequency bands. Each frequency band may comprise an array of time amplitude values. For example, a frequency band ranging from 40 Hz to 100 Hz may comprise the array of time amplitude values for frequencies between 40 Hz and 100 Hz (includes frequencies 40 Hz and 100 Hz).

Parallelly, the preprocessed audio signal is passed to the DC offset module 408. The DC offset module 408 ensures that the preprocessed audio signal always has a non-zero value during an audio silence. This is achieved by adding a small value (like 0.01) to the audio sampled values so that the sampled values are always non-zero, that is, the sampled values always have a positive value. The processed signal is then passed to the spectral centroid module 410, which calculates the spectral centroid or the center of mass of the received signal. The array of time amplitude values and the array of spectral centroid values are calculated in parallel for the audio signal. In an alternative embodiment, the array of time amplitude values and the spectral centroid values are calculated separately.

To calculate the spectral centroid of the received audio signal from the preprocessor module 202, the preprocessed audio signal is transformed into a frequency domain by performing a Short Time Fourier Transform (STFT) or Fast Fourier Transform (FFT). The spectral centroid of a predefined number of samples is calculated by using a weighted average method. In some embodiments, the number of samples may be fixed. Alternatively, the audio analysis module 206 may automatically determine the number of samples required for calculating the spectral centroid. The average frequency of each frequency interval is calculated; the average frequency is multiplied by the spectral energy of that frequency interval to calculate the spectral energy distribution for that frequency band. Similarly, the spectral energy distribution for all frequency bands is calculated. The sum of energy frequency distribution of all the frequency bands is divided by the sum of the average frequency of all the frequency bands to arrive at the spectral centroid. To calculate the array of spectral centroid values, a fixed number of samples are removed and an equal number of samples are added. For example if the buffer size of the frame of the preprocessed audio signal is 1024 samples, each iteration may replace 128 samples and introduce 128 new samples. In this example, the array of spectral centroid values may be obtained. In some embodiments, the iteration is performed by replacing a fixed number of samples for calculating the time amplitude values and spectral centroid values.

In some embodiments, the spectral centroid value may be calculated using a fixed number of audio frames. Furthermore, the array of spectral centroid values may be calculated by replacing a fixed number of audio frames by an equal number of audio frames. For example if the buffer size of the frame of the preprocessed audio signal is 1024 audio frames, each iteration may replace 128 audio frames and introduce 128 new audio frames to be processed.

In some embodiments, the spectral centroid value may be calculated using a fixed window size comprising audio data or audio video data. In this implementation, the array of spectral centroid values may be calculated by removing a fixed number of audio data and shifting the window to include an equal number of additional unprocessed audio data. For example if the window size of the preprocessed audio signal is 1024 units, each iteration may replace 128 audio data units and introduce new unprocessed 128 audio units. In some embodiments, the window size is automatically calculated by the audio analysis module 206.

The array of time amplitude values and the array of spectral centroid values are passed to the authoring module 208. The authoring module 208 includes a user interface that allows the editing and/or modification of the array of time amplitude values and the array of spectral centroid values.

In some embodiments, the authoring module 208 is connected with the database 220 having the actuator specific information 222 and the device specific information 224 to allow a user to adjust the array of amplitude time values and the array of spectral centroid values according to electronic computing device 102 having an embedded actuator 122 or an actuator 126. In one variation of this implementation, the device specific information 224 may include the actuator specific information 222. For example, when the actuator 122 is embedded within the electronic computing device 102, the device specific information 224 may include the actuator specific information 222.

The transformation module 210 receives the authored array of time amplitude values and the authored array of spectral centroid values to determine if the authored array of time amplitude values and the authored array of spectral centroid values can fit within a haptic perceptual bandwidth for each of the frequency bands.

The combined bandwidth of the actuator and the electronic computing device, where the human can feel vibration, is referred to as “haptic perceptual bandwidth”. The haptic perceptual bandwidth can be calculated from the actuator specific information 222 and device specific information 224 stored in the database module 220. To illustrate the haptic perceptual bandwidth through an example, let the bandwidth of the actuator 122 be 40 Hz and the bandwidth of the electronic computing device 102 be 120 Hz then if the human can perceive the vibration is 80 Hz then the combined haptic perceptual bandwidth of the electronic computing device 102 having the embedded actuator is 80 Hz. If the authored array of time amplitude values and the authored array of spectral centroid values can fit within a haptic perceptual bandwidth for each of the frequency bands, then the array of time amplitude values and the spectral centroid values is passed to an aggregation and file management module 212 for creating a computer readable haptic file. The computer readable haptic file can be parsed by the actuator 126.

Otherwise, the authored array of time amplitude values and the authored array of spectral centroid values are transformed into a transformed array of time amplitude values and a transformed array of the spectral centroid values by implementing an algorithm. The algorithm performs the steps of determining the rank of each frequency band, if the frequency band ranks are not already provided. If the frequency bands are not ranked, then the algorithm calculates the rank of each frequency band. Subsequently, the algorithm tries to fit the transformed array of time amplitude values and the transformed array of the spectral centroid values based on the ranking of the frequency bands. When only one frequency band can fit into the haptic perceptual bandwidth, the algorithm performs the processes of shifting of frequency bands. To perform the process of shifting the frequency bands, the algorithm determines the resonant frequency of the electronic computing devices 102 (along with the actuator 122) and calculates the distance between the determined resonant frequency and the nearest frequency band. The positive value of the calculated distance is always used. The nearest frequency band is shifted to the resonant frequency of the electronic computing device 102. The algorithm then shifts all the other frequency bands so that they lie close to the resonant frequency of the electronic computing device 102. The algorithm then determines if all the frequency bands can be accommodated within the haptic perceptual bandwidth. If all the frequency bands can be accommodated or fit into the haptic perceptual bandwidth then the algorithm fits all the frequency bands into the haptic perceptual bandwidth. Otherwise, the algorithm fits the frequency bands based on the rank of each frequency band. The frequency bands are accommodated based on descending order of ranks, that is, the highest ones are accommodated before the lower ranked frequency bands. For example, the frequency band f1 is ranked 2, frequency f3 is ranked 1, frequency band f2, is ranked 3 then the frequency bands are accommodated in the order f3, f1 and f2. If all the frequency bands cannot be accommodated then the frequency bands that cannot be accommodated into the haptic perceptual bandwidth are discarded. For example, if the frequency band f2 cannot be accumulated into the haptic perceptual bandwidth then the frequency band f2 is discarded.

If no frequency ranks are provided, then the algorithm ranks the frequency bands before shifting the frequency bands. When only one frequency band, which is nearest to the resonant frequency, can be accommodated within the haptic perpetual bandwidth, then the algorithm shifts that frequency band and eliminates all the other frequency bands.

The output of the algorithm is the transformed audio descriptor data comprising a transformed array of time amplitude values and a transformed array of spectral centroid values, which is provided to an aggregation and file management module 212. The aggregation and file management module 212 converts the transformed audio descriptor data into a computer readable haptic file.

Subsequently, the output of the aggregation and file management module 212 is saved as a computer readable haptic file, which can be parsed and processed by the resynthesis module 214. The resynthesis module 214 processes the transformed audio descriptor data stored in the computer readable haptic file to produce haptic experience in one or more actuators 122 or one or more actuators 126.

In one variation of this implementation, the array of time amplitude values control the amplitude of the actuator whereas the array of spectral centroid values provide the corresponding frequency to be set in one or more actuators for providing an immersive haptic experience.

FIG. 4B illustrates the various components of an audio analysis module implementing a filter bank for converting an audio signal into a haptic output in another embodiment. The audio analysis module 206 receives the preprocessed audio signal from the audio preprocessor module 202. The audio analysis module 206 comprises a filter bank 440, an envelope follower 450, an envelope smoother 460, and a data reduction 470.

The audio signal received from the audio preprocessor module 202 is separated into different frequency bands by the filter bank 440. Each frequency band has a center frequency and bandwidth. In some embodiments, the center frequency may be a median value or the modal value of the frequencies of the frequency band. In some embodiments, the centre frequency and the bandwidth of each frequency band can be selected by a user through a Graphical User Interface (GUI) of the authoring tool 208.

The filter bank 440 includes a band filter 422, a band filter 424, a band filter 426, and a band filter 428. Each band filter is tuned to pass a predefined band of frequencies. Although only four band filters are shown in the filter bank 440, in other variations the filter bank 440 may include more than or less number of band filters. Each filter band may be tuned to different frequencies. For example, the band filter 422 may be tuned to pass 0-60 Hz. Likewise, the band filter 424 may be tuned to pass frequencies tuned at 60-120 Hz. Similarly, the band filter 426 may be tuned for frequencies ranging from 120-180 Hz. In some embodiments, each band filter can be tuned at an unequal frequency range. For example, the band filter 422 is tuned for frequencies ranging from 20 to 60 Hz; the band filter 424 is tuned to band frequencies ranging from 60-120 Hz; the band filter 426 may be tuned to frequencies ranging from 120 to 200 Hz; the band filter 428 may be tuned to frequencies ranging from 200 Hz to 1 kHz. The output of the filter bank 440 is a plurality of filtered audio signals, each signal belonging to one frequency band. For example, each band filter such as the band filter 422, the band filter 424, the band filter 426, and the band filter 428 produce an audio signal as per the tuned frequency band of the band filter.

The output of the filter bank 440 is provided to the envelope follower 450. The envelope follower 450 includes a band envelope approximation 452, a band envelope approximation 454, a band envelope approximation 456, and a band envelope approximation 458. In the current implementation, the band envelope approximation 452 receives the filtered audio signal from the band filter 422. Likewise, the band envelope approximation 454, the band envelope approximation 456, and the band envelope approximation 458 receive the filtered audio signal from the band filter 424, the band filter 426, and the band filter 428 respectively. The center frequency of each band filter can be evenly spaced over a frequency range in a linear or logarithmic scale.

The envelope follower 460 generates a time-amplitude envelope for each frequency band. The centre frequency for each frequency band is included in the time amplitude envelope. The envelope follower 460 includes a band envelope approximation module 452, a band envelope approximation module 454, a band envelope approximation module 456, and a band envelope approximation module 458. Each band approximation module implements one or more envelope approximation algorithms. Each band approximation module such as band approximation module 452 can have at least one envelope follower, a memory bank, and an optional processor. Furthermore, in the current implementation, the envelope follower 450 is utilized for generating time amplitude envelope for one or more frequency band using the band envelope approximation such as band envelope approximation 458, however, in other implementations, the envelope follower 450 may implement other type of envelope approximation methods, for example, a Hilbert transformation. For each frequency band, the time amplitude envelope is approximated into an array of time amplitude values/data points that best represents the amplitude values over time for each frequency band.

The output of the envelope follower 450 is passed to the envelope smoother 460. The envelope smoother 460 includes a band envelope smoother 462, a band envelope smoother 464, a band envelope smoother 466, and band envelope smoother 468. In the current implementation, the band envelope smoother 462 receives the time-amplitude envelope from the band envelope approximation 452. Likewise, the band envelope smoother 464, the band envelope smoother 466, and the band envelope smoother 468 receive the time-amplitude envelope from the band envelope approximation 454, the band envelope approximation 456, and the band envelope approximation 458 respectively.

The band envelope smoother 460 smoothens the time amplitude envelope to reduce abrupt signal changes in order to generate a smooth time amplitude envelope at the center frequency for each of the frequency bands. Due to large variations in the amplitude values, there can be abrupt signal changes; these abrupt signal changes are smoothened using the envelope smoother 460. The smoothing process eliminates outliers, clips of sharp peaks, and produces a smoothed time-amplitude envelope for each frequency band. The band envelope smoother 460 has multiple band smoothers, one for each of the frequency bands. Each band envelope smoother such as the band envelope smoother 462 includes at least one digital filter, a memory bank, and an optional processor. Each band envelope smoother such as the band envelope smoothers 462 can be a digital filter, for example, the digital filter can be a low-pass Butterworth filter with a cut-off frequency of 250 Hz. However, in other implementations, the band envelope smoother 462 may include different types of digital filters, which may be set to different cut-off values ranging between 30 Hz to 1000 Hz.

The output of the envelope smoother 460 is passed to the data reduction 470. the band data. The data reduction 470 includes a band data reduction 472, a band data reduction 474, a band data reduction 476, and a band data reduction 478. The band data reduction 472 receives the smoothed time amplitude envelope from the band envelope smoother 460. Likewise, the band data reduction 474, the band data reduction 476, and the band data reduction 478 receive the smoothed time-amplitude envelope from the band envelope smoother 464, the band envelope smoother 466, and the band envelope smoother 468.

The data reduction 470 reduces the number of time amplitude data points or the time amplitude values of the smoothened time-amplitude envelope to produce a reduced time amplitude band envelope. For each band data reduction such as band data reduction 472 the produced reduced time amplitude values. The array of reduced time amplitude band envelopes includes the center frequency and array of reduced time amplitude values/data points for each frequency band. The data reduction 470 may include a memory bank and an optional processor. The data reduction 470 reduces the smoothed time amplitude envelope into a minimum number of time amplitude values/data points. The reduced time amplitude values are generated without losing information or losing minimal information. Finally, the audio analysis module 206 produces an analyzed array of time amplitude values, the centre frequency, and an array of time frequency values for each frequency band.

For each frequency band, the audio analysis module 206 may process the received audio signal to produce an array of time amplitude values, a centre frequency and an array of spectral centroid values as described in FIG. 4A. Each frequency band may be analyzed separately and passed to the authoring tool 208 for authoring the array of time amplitude values, the centre frequency and the array of spectral centroid values for each frequency band. Thereafter, the authored array of time amplitude values, the authored centre frequency and the authored array of spectral centroid values for each frequency band is provided to the transformation module 208 for generating the transformed audio descriptor data.

In one implementation, the data reduction 470 utilizes the Ramer-Douglas-Peucker data reduction algorithm in order to minimize the amount of time-amplitude data points to a manageable proportion. In different implementations, the data reduction algorithms can include piecewise linear approximation methods such as, but not limited to, RLS (recursive least square), Visvalingam-Wyatt, differential evolution, Broyden-Fletcher—Goldfarb-Shanno (BFGS), gradient descent and other known techniques.

In a different implementation, the audio analysis module 206 may include an audio analysis processor, a digital signal processor, and a memory to store and execute envelope smoothing algorithms and techniques, for example, numerical analysis, B -splines, AI algorithms and other known techniques.

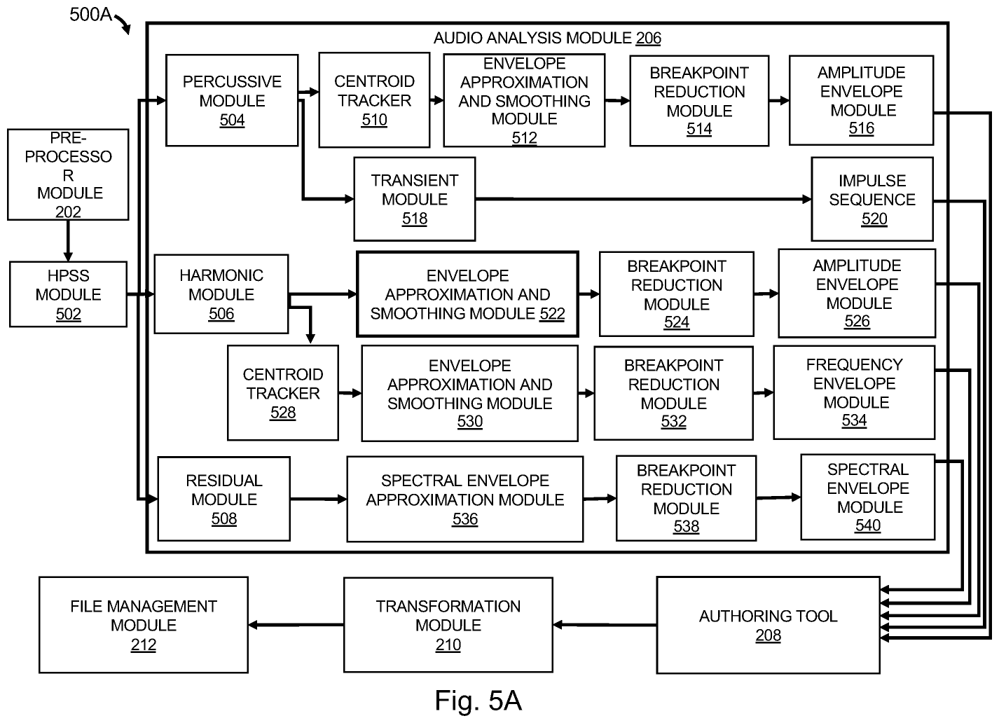

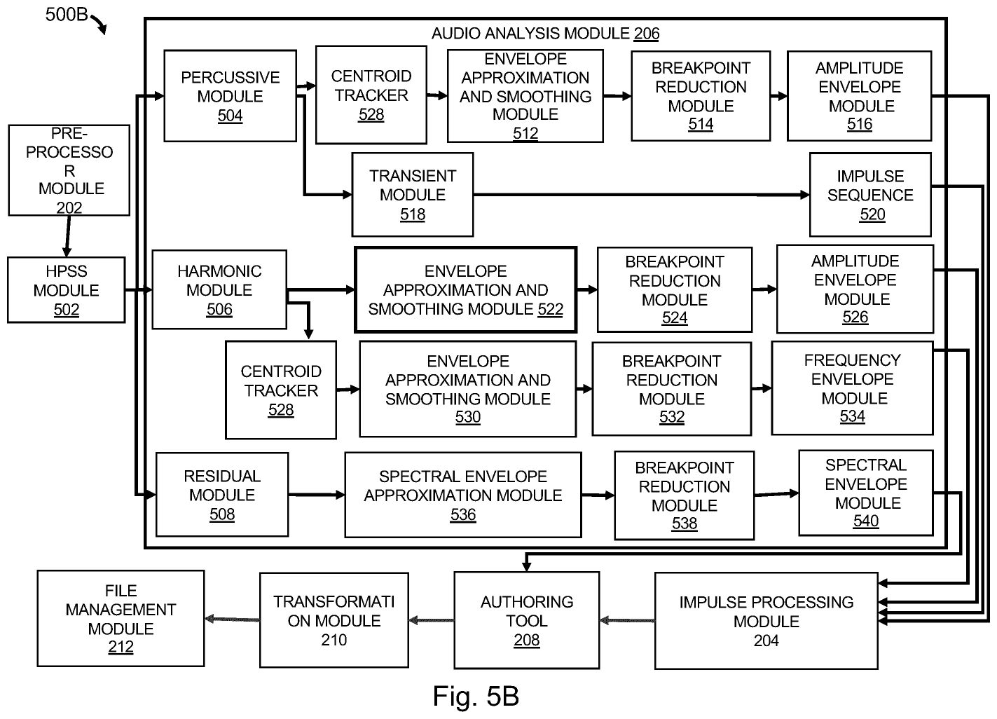

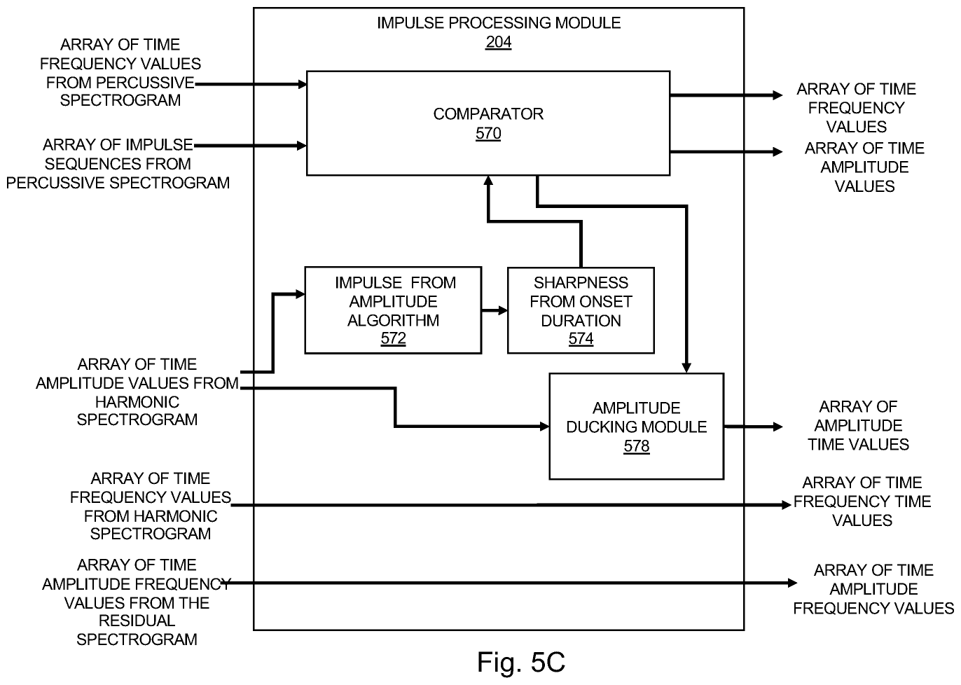

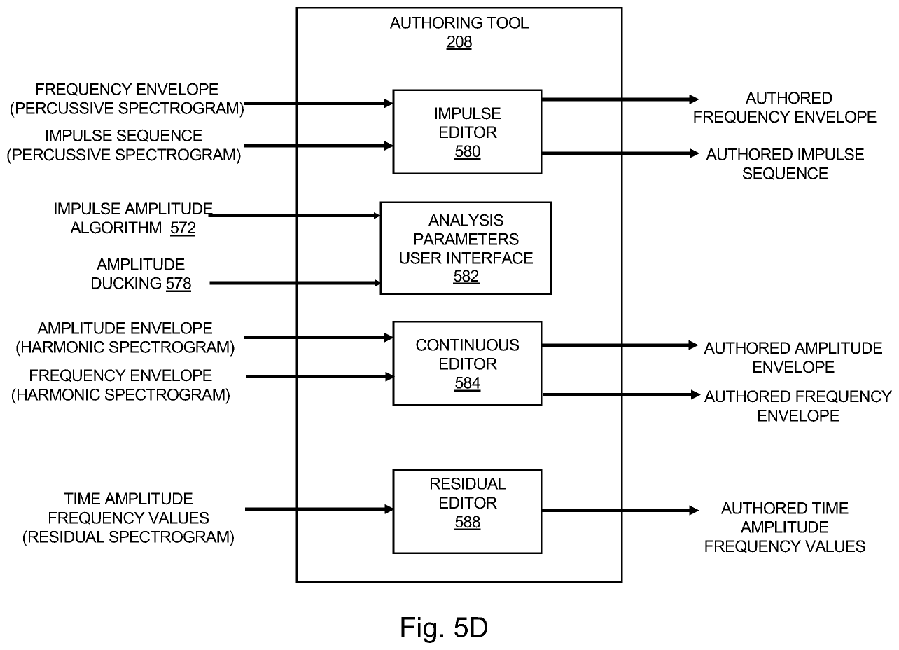

FIG. 5A illustrates the block diagram of an audio analysis module implementing a harmonic-percussive source separation for converting an audio signal into a haptic output in an embodiment. The audio analysis module 206 receives the preprocessed audio signal from the preprocessed module 202 and passes it to a HPSS module 502 to produce a power spectrogram. In one variation of this implementation, the HPSS module 502 resides in the audio analysis module 206. In another variation of this implementation, the HPSS module 502 is a separate module associated with the audio analysis module 206. The HPSS module 502 performs the Short Time Fourier Transform (STFT) or Fast Fourier Transform (FFT) of the received audio signal from the received preprocessor module 202. The power spectrogram from the HPSS module 502 is passed to a harmonic module 506, a percussive module 504, and a residual module 508.

The percussive module 504 receives the power spectrogram from the HPSS module 502. The percussive module 504 filters the power spectrogram to produce a percussive spectrogram. Simultaneously, the harmonic module 506 receives the power spectrogram and filters it to produce a harmonic spectrogram. The residual module 508 calculates the residual spectrogram by adding the harmonic spectrogram and the percussive spectrogram and then subtracting the sum of the harmonic spectrogram and the percussive spectrogram from the power spectrogram. The power spectrogram may be filtered horizontally and/or vertically to produce the harmonic spectrogram and/or the percussive spectrogram.

The percussive spectrogram from the percussive module 504 is passed to a centroid tracker 510 to calculate the spectral centroid of the percussive spectrogram. The spectral centroid may be calculated for a fixed frame of audio data. Alternatively, the spectral centroid may be calculated for fixed window size of the audio data packets or variable window size of the audio data packets. After calculating the spectral centroid of the percussive spectrogram, the spectral centroid values are passed to an envelope approximation and smoothing module 512. The envelope approximation and smoothing module 512 perform the function of (a) approximate the preprocessed audio signal into an time amplitude frequency values, and (b) smoothen the approximated time amplitude frequency values. The output is the array of time amplitude frequency values, which is then passed to a breakpoint reduction module 514. The breakpoint reduction module 514 reduces the array of time amplitude frequency values based on a linear approximation of a time sequence to produce an array of time amplitude frequency values with best fit approximation and minimum number of data points or data values without losing any information in the audio signal or minimizing the loss of information in the audio signal. Finally, the array of time amplitude values are provided to an amplitude envelope module 516 for extracting the time amplitude envelope comprising an array of time amplitude values.

Simultaneously, the percussive spectrogram from the percussive module 502 is passed to the transient module 518. The transient module 518 detects the presence of transients in the percussive spectrogram. The transient processing is discussed in detail in the US application Ser. No. 16/435,341 (which is incorporated here by reference). When transients are detected in the percussive spectrogram, the transient module 518 passes the transients to an impulse sequence module 520, which produces a sequence of impulses. The impulse sequence comprises an array of time frequency values. In one variation of this implementation, the impulse sequence may comprise an array of time frequency values, an array of time amplitude values and/or array of time amplitude frequency values.

The harmonic module 506 produces the harmonic spectrogram, which is passed simultaneously to an envelope approximation and smoothing module 522 and to a centroid tracker 528. The harmonic spectrogram is passed to the envelope approximation and smoothing module 522, which produces an array of amplitude frequency time values. The envelope approximation and smoothing module 522 perform the function of (a) approximate the preprocessed audio signal into an time amplitude frequency values, and (b) smoothen the approximated time amplitude frequency values. The array of time amplitude frequency values is then passed to a breakpoint reduction module 524. The breakpoint reduction module 524 reduces the array of time amplitude frequency values based on a linear approximation of a time sequence. Finally, the array of time amplitude values are provided to an amplitude envelope module 526 for extracting the time amplitude envelope having an array of time amplitude values.

The harmonic spectrogram, in parallel, is provided to the centroid tracker 528 to calculate an array of spectral centroid values of the harmonic spectrogram. . The array of spectral centroid values is passed to an envelope approximation and smoothing module 530 to (a) approximate the preprocessed audio signal into an array of time frequency values, and (b) smoothen the approximated array of spectral centroid values. The array of spectral centroid values is then passed to a breakpoint reduction module 532. The breakpoint reduction module 532 reduces an array of spectral centroid values based on a linear approximation of a time sequence. Finally, the array of spectral centroid values are passed to a frequency envelope module 534 for providing a frequency envelope comprising an array of time frequency values.

The residual module 508 calculates the residual spectrogram from the power spectrogram and passes the residual spectrogram to a spectral envelope approximation module 536. The spectral envelope approximation module 536 performs (a) approximates the residual spectrogram into an array of time amplitude frequency values, and (b) smoothen the time amplitude frequency values. The array of time amplitude frequency values is then passed to the breakpoint reduction module 538. The breakpoint reduction module 538 reduces the array of time amplitude frequency values based on a linear approximation of a time sequence. Finally, the array of time amplitude frequency values are passed to a spectral envelope module 540 for extracting a residual array of time amplitude frequency values.

In some embodiments, the envelope approximation and smoothing module 512 calculates the array of time frequency values for a fixed number of samples or fixed time.

In some embodiments, the array of spectral centroid values is calculated for a predefined number of samples over a fixed time or for a fixed number of samples, that is, a fixed window size.

To calculate the array of spectral centroid values, the Fast Fourier Transform or Short Time Fourier Transform is taken for a fixed number of samples to generate a spectrum of spectral energy vs. frequency. For each frequency band, the average frequency is calculated; the average frequency of each frequency band is multiplied by the spectral energy of that frequency band. The sum of the product of average frequency and spectral energy of all frequency bands is calculated, which is divided by the sum of spectral energies of all frequency bands. After calculating the spectral centroid, the samples are left shifted, that is, removing the predefined number of samples and introducing the same number of new samples. Subsequently, the spectral centroid is calculated for these sampled values. This results in an array of spectral centroid values produced, which are provided to the authoring module 208 for authoring a percussive stream, a harmonic stream, and a residual stream.

In some embodiments, the authoring module 208 may allow the editing, addition, deletion or modification of the array of spectral centroid values.

FIG. 5B illustrates the block diagram of an audio analysis module implementing a harmonic-percussive source separation for converting an audio signal into a haptic output in another embodiment. The haptic processing system 500B includes an additional impulse processing module 204 in this alternate implementation. The array of time amplitude values from the amplitude envelope module 516 and the array of impulse sequences from the impulse sequence module 520 processed from the percussive spectrogram. The array of time amplitude values from the amplitude envelope module 526and the array of time frequency values from the amplitude envelope 534 processed from the harmonic spectrogram are provided to an impulse processing module 204. The impulse processing module 204 implements algorithms for the amplitude envelope module 516 and the amplitude envelope module 526 to estimate the occurrence of an impulse (i.e. transient/emphasis) for any given breakpoint in each amplitude envelope received from the amplitude envelope module 516 and the amplitude envelope module 526. A comparator then compares the impulse sequence 520 with the resulting impulse sequences derived from the amplitude envelope module 516 and the amplitude envelope module 526 to add or remove impulses. The impulse processing module 204 can make changes to the timing of each impulse, so that the transients are consistent and aligned with the audio signal. Furthermore, the frequency information from the frequency envelope 534 is utilized to set the sharpness (frequency) value for each impulse returned by the impulse processing module 204.

In addition, the impulse processing module 204 monitors the ducking to the amplitude envelope, This allows the emphasis on the impulses during haptic synthesis providing an immersive haptic experience. The output of the impulse processing module 204 is provided to the authoring tool 208 and subsequently to the transformation module 210. Finally, the transformed array of time amplitude values, the transformed array of impulse sequences, and the transformed array of time frequency values are provided to the aggregation and file management module 212 to create a computer readable haptic file.

FIG. 5C illustrates the block diagram of the impulse processing module in an embodiment. The impulse processing module 204 comprises a comparator module 570, an impulse amplitude algorithm module 572, a sharpness and onset module 574 and an amplitude ducking module 578. In some embodiments, different modules of the impulse processing module 204 may have a processor and an associated memory.

The comparator module 570 receives the array of centroid frequency values from the harmonic spectrogram and an array of impulse sequences from the percussive spectrogram. In addition, the comparator module 570 also receives an input from the sharpness and onset module 574. The impulse amplitude algorithm module 572 receives the array of time amplitude values from the harmonic spectrogram, processes the array of time amplitude values and passes the same to the sharpness and onset module 574. The array of time amplitude values from the harmonic spectrogram is also passed to the amplitude ducking module 578.

In some embodiments, the amplitude ducking may be performed continuously at least a few milliseconds before the actual impulse sequence. In different embodiments, the time duration may vary from 0.5 ms to 100 ms. In the preferred embodiment, the amplitude ducking may be performed at 0.5 ms to 15 ms before the arrival of the impulse sequence.

In some embodiments, the amplitude ducking may be performed based on deep learning algorithms or other artificial intelligence algorithms. The timing and duration of the amplitude ducking is determined by deep learning algorithms, which have been previously trained using test data.

In some embodiments, the amplitude ducking may be performed based at least on one of the device specific information, the actuator specific information and game context specific information.

In some embodiments, the amplitude ducking may be performed based on the previous data corresponding to the array of time amplitude and the array of time frequency values.

In some embodiments, the amplitude ducking may be implemented with a time delay. The delay may be of fixed time or a variable time. In some embodiments, the time delay may be implemented using deep learning algorithms. Additionally, the machine learning algorithms may implement the delay that may be different for different impulse sequences. For example, the delay of 1 ms for the first set of impulses and 5 ms for the second set of impulses.

In some embodiments, the amplitude ducking may be controlled by the comparator based on the look ahead algorithm. The look ahead information received by implementing the look ahead algorithm may be based at least on the audio data such as amplitude, frequency and phase.

The comparator 570 also provides feedback to the amplitude ducking module 578. The purpose of providing the feedback from the comparator 570 to the amplitude ducking 578 is to ensure that the impulse signals generated by both the percussive audio stream and the harmonic audio stream do not interfere with each other. The continuous audio stream is generated by the array of time amplitude values corresponding to the harmonic spectrogram. Thus, whenever the impulse or sequence of impulses are detected by the comparator 570, a feedback is passed to the amplitude ducking 578, which suppresses the continuous audio stream of the harmonic spectrogram until the impulse/ impulse sequence has passed. This ensures a good haptic experience. The output of the comparator 570 is an array of time frequency values and an array of time amplitude values for impulse generation.

In some embodiments, the amplitude ducking 578 may partially suppress the amplitude of the continuous signal, for example, the amplitude of the continuous stream is reduced by a fixed percentage, for example 25%. In another implementation, the amplitude of the continuous stream is reduced by 100%. In other implementations the amplitude of the continuous stream is reduced between 50% -90%.

The impulse processing module 204 utilizes both the harmonic spectrogram and the percussive spectrogram to generate impulses.

In some embodiments, the array of time frequency values and the array of time amplitude values for impulse generation is passed to an impulse actuator for producing the haptic effect. In embodiments, the impulse actuator may be an LRA, an ERM, a wideband actuator, a piezo actuator or some other type of actuator.

In some embodiments, at least two different actuators are connected to play back the haptic effect. The first actuator that produces the impulse effect is connected to the array of frequency time values and the amplitude of the first actuator is controlled by the array of the time amplitude values, which is obtained from both the percussive spectrogram and the harmonic spectrogram. The second actuator is controlled by the array of time frequency values and the array of amplitude time values to produce a continuous haptic effect.

In some embodiments, the continuous haptic effect produced by the second actuator may be ducked to accommodate the impulse haptic effect produced by the first actuator. The amplitude ducking provides a better haptic experience.

FIG. 5D illustrates the block diagram of an authoring tool for processing audio data in an embodiment. The authoring tool 208 comprises an impulse editor 580, an analysis parameters user interface 582, a continuous editor 584 and a residual editor 588 apart from other interface tools. The impulse editor 580 allows the user to modify and/or edit the array of time frequency values of the frequency envelope and the array of impulse sequence values for the percussive spectrogram. The output of the impulse editor 580 is an authored frequency envelope comprising the array of time frequency values and an authored array of impulse sequences comprising the array of time amplitude values.

The analysis parameters user interface 582 allows the user to adjust the one or more parameter values received from the impulse processing system 204. The impulse values may be calculated by the gradient at specific signal values. The change in the gradient is greater than a predetermined value a sequence of impulses emerge. The user may modify and/or adjust these impulses. For example, the user may modify the amplitude of each impulse or eliminate one or more impulses. The analysis parameters user interface 582 also allows the user to edit/change/modify or adjust the parameters in the impulse amplitude algorithm 572 and the amplitude ducking 578.

The array of time amplitude values from the amplitude envelope module of the harmonic module 506 and the array of time frequency values from the frequency envelope associated with harmonic module 506 can be edited or adjusted using a continuous editor 584. Likewise, the array of time amplitude frequency values from the residual spectrogram 508 can be edited or modified by a residual editor 586. For example, the user may edit the array of time amplitude values from the amplitude envelope module of the harmonic module 506 and the array of time frequency values from the frequency envelope associated with harmonic module 506 to adjust the haptic feedback.

In some embodiments, the user may create two sets of authored array of time amplitude values and the authored array of time frequency values one for normal power mode and another set of values for low power mode. In this implementation, the amplitudes of the amplitude envelope comprising the array of time amplitude values and the frequency envelope comprising the array of time frequency values may be modified to reduce the power consumption in the low power mode. For example, the amplitude may be scaled by 25 percent and an amplitude threshold is provided. The haptic feedback may occur only when the amplitude is above the amplitude threshold value.

The output from the authoring tool 208 comprises the authored array of time frequency values and the authored array of time amplitude values of the continuous stream edited using the continuous editor 584; the authored array of impulse sequence having array of amplitude time values and the authored array of time frequency values from the impulse editor 582 and optionally the authored array of amplitude frequency time values from the residual editor 586.

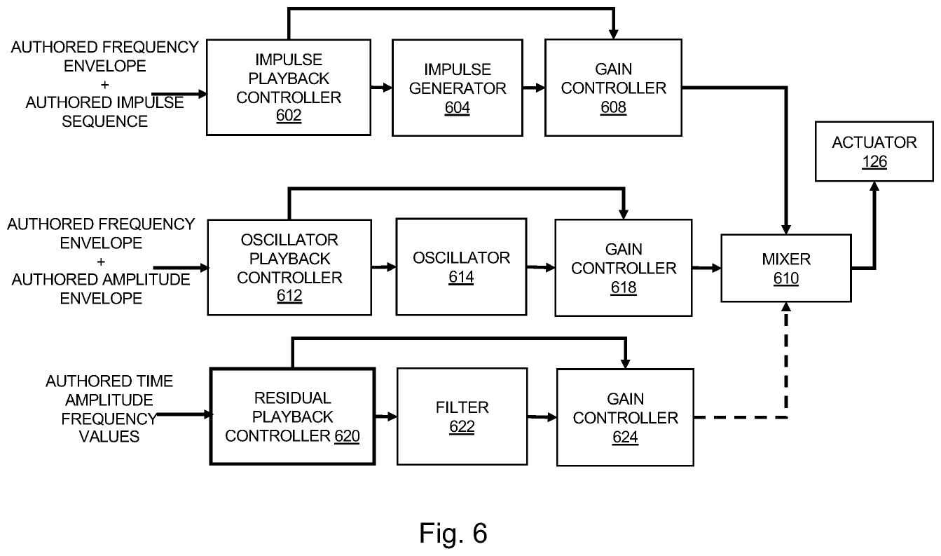

FIG. 6 illustrates a block diagram for processing an authored array of time frequency and an authored array of time frequency values in an embodiment. The authored array of the continuous stream, the authored array of the impulse stream, and the authored array of the residual stream are provided to different playback controllers for generating haptic experience.

The output from the impulse editor 580 comprising the authored frequency envelope having the authored array of time frequency values and the authored array of impulse sequence having the authored array of time amplitude values received from the percussive spectrogram is passed to an impulse playback controller 602. The impulse playback controller 602 receives the frequency envelope and the authored array of the impulse sequence, analyzes it, and extracts the impulse sequence. In addition, the frequency of each impulse is also determined. The extracted impulses and their corresponding frequencies are passed on to an impulse generator 604. The impulse generator 604 generates impulse signals based on the array of frequency values. The impulse playback controller 602 provides feedback to a gain controller 592. The output from the impulse generator 604 is provided to the gain controller 608. The gain controller 608 also receives a feedback signal from the impulse playback controller 602 to adjust the gain of the impulse signals. The output of the gain controller 608 is provided to a mixer 610.

Likewise, the output of the continuous editor 584 is provided to an oscillator playback controller 612. The oscillator playback controller 612 receives the amplitude envelope comprising the authored array of time amplitude values and a frequency envelope comprising an authored array of time frequency values. The oscillator playback controller 612 receives the amplitude envelope and the frequency envelope to generate a haptic signal, which is passed to an oscillator 614. The oscillator 614 generates a continuous haptic signal at frequencies and amplitudes received from the oscillator playback controller 612. The output from the oscillator playback controller 612 is provided to a gain controller 618 as feedback. The gain controller 618 adjusts the gain, that is, the amplitude of the haptic signal based on the feedback provided by the oscillator playback controller 612. The output of the gain controller 618 is passed to the mixer 610.

In one variation of the implementation, the authored array of time amplitude frequency values received from the residual editor 586 is processed by a residual playback controller 620. The residual playback controller 620 receives the authored array of time amplitude frequency time values and extracts time amplitude frequency values. The time amplitude frequency values are passed to a filter 622, which filters the received time amplitude frequency values based on preset filter parameters. The output of the filter 622 is provided to a gain controller 624. The gain controller 624 also receives a feedback signal from the residual playback controller 620 and accordingly adjusts the gain or the amplitude based on the array of time amplitude frequency values. The inclusion of processing of the residual signal is optional and may be implemented based on predetermined criteria. For example, a substantial presence of a noise component in the authored signal.

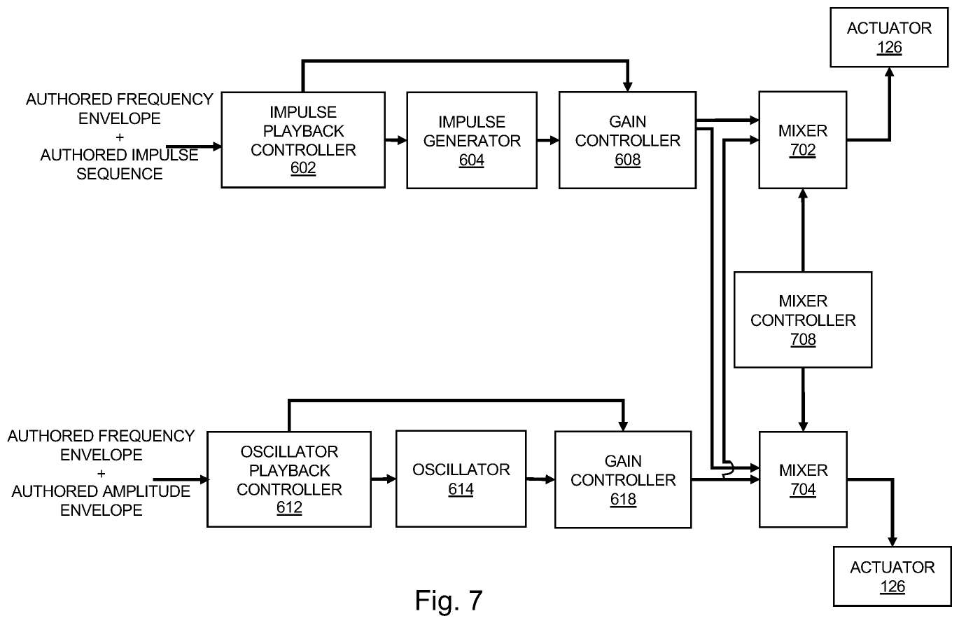

FIG. 7 illustrates a block diagram for processing an authored array of time frequency and an authored array of time frequency values in another embodiment. In this implementation at least two actuators are used. The authored frequency envelope and the authored impulse sequence are passed to the impulse playback controller 602 and the authored frequency envelope and the authored amplitude envelope are passed to the oscillator playback controller 612. The output of the impulse playback controller 602 is passed to the impulse generator 604 and to the gain controller 608. Likewise, the output of the oscillator playback controller 612 to the oscillator 614 and finally to the gain controller 618. In this implementation, the output from the gain controller 608 is passed to a mixer 702 and the output from the gain controller 618 is provided to a mixer 704. Feedback from the impulse playback controller 602 is provided to the gain controller 608. Similarly, feedback from the oscillator playback controller 612 is provided to the gain controller 618.

The mixer 702 and the mixer 704 are controlled by a mixer controller 708. The mixer controller 708 controls the haptic effect produced by the two actuators 126. In one implementation, the two actuators 126 may have similar specifications. In another implementation, the two actuators 126 may have different specifications. For example, at least one actuator 126 may be an LRA and another actuator 126 may be a voice coil.

In this variation, the impulse playback controller 602, the impulse generator 604 and the gain controller 608 drive the first actuator 126 through the mixer 702. The actuator 126 receives a feedback signal from the mixer 704 that is associated with the oscillator playback controller 612, the oscillator 614, the gain controller 618. In addition, the first actuator 126 is controlled by the mixer controller 708 that controls the amount of haptic feedback to be provided to each of the actuators 126. Likewise, the oscillator playback controller 612, the oscillator 614, the gain controller 618 drive the second actuator 126 through the mixer 704. The second actuator 126 also receives feedback from the mixer 702 associated with the impulse playback controller 602, the impulse generator 604 and the gain controller 608. Additionally, the second actuator 126 is controlled by the mixer controller 708 that controls the amount of haptic feedback to be provided to each of the actuators 126. The mixer controller 708 provides a balance between the haptic effect produced by the impulse signal and the continuous signal. It should be noted that the first actuator 126 and the second actuator 126 in combination provide an immersive haptic experience by processing the impulse signal in the first actuator 126 and the continuous signal played in the second actuator 126. Other combinations with more than two actuators 126 are possible in this embodiment. For example, the two or more actuators 126 can be attached to the mixer 702. Likewise, two or more actuators 126 can be attached to the mixer 704.

In some embodiments, the mixer 702 and the mixer 704 are controlled by a mixer controller 708. The mixer controller 708 may adjust the ratio of the impulse signal and the continuous signal to control the functioning of the two actuators 126.

In another variation of this implementation, the mixer controller 708 may receives input from the device specific information 224, the actuator specific information 222, and the content specific information 226 for adjusting the ratio of impulse signal and the continuous signal for optimal performance for a combination of the actuators 122 or the actuators 126 associated with the electronic computing device 102.

In some embodiments, the adjustment may also happen dynamically based on the content specific information 226. In some other embodiments, the mixer controller 708 may implement machine learning and analytics to predict the optimum ratios of the impulse signal and the continuous signal to control the functioning of the two actuators 126.

In some embodiments, the mixer 702 receives the output from the gain controller 608 and the mixer 704 receives the output from the gain controller 618. The output from the mixer 702 and the mixer 704 is controlled by the mixer controller 708. In some embodiments, the mixer controller 708 implements deep learning algorithms for dynamically controlling the mixing of the impulse signal and the continuous signal.

In some embodiments, the output of the gain controller 608 is provided to the mixer 702 and simultaneously to the mixer 704. Similarly, the output of the gain controller 618 is provided to the mixer 702 and to the mixer 704. In addition, the output of the gain controller 608 and the gain controller 618 is also provided to the mixer controller 708, which controls the mixing of the signals, that is, the impulse signal (transients) and the continuous signal in appropriate proportion for immersive haptic experience. In one variation of this implementation, the mixer controller 708 may include deep learning algorithms that implement learning algorithms to control the mixing of the signals from the gain controller 608 and the gain controller 618.

In some embodiments, the mixer controller 708 may be associated with an analytics AI, machine learning and may apply a mix ratio of the continuous haptic stream and the impulse haptic stream depending on the incoming content. For example, quiet content has a 70/30 ratio and louder, more dynamic content has a 50/50 ratio.

In one variation of this embodiment, a transformed array of the continuous stream, a transformed array of the impulse stream, and a transformed array of the residual stream are provided to different playback controllers for generating haptic experience. In this implementation, the processing of the continuous stream and the impulse stream may happen exactly as disclosed in FIG. 6 and FIG. 7. Furthermore, the mixer 702, the mixer 704 and the mixer controller 708 may be configured in similar configuration and may operate as described in FIG. 6 or FIG. 7.

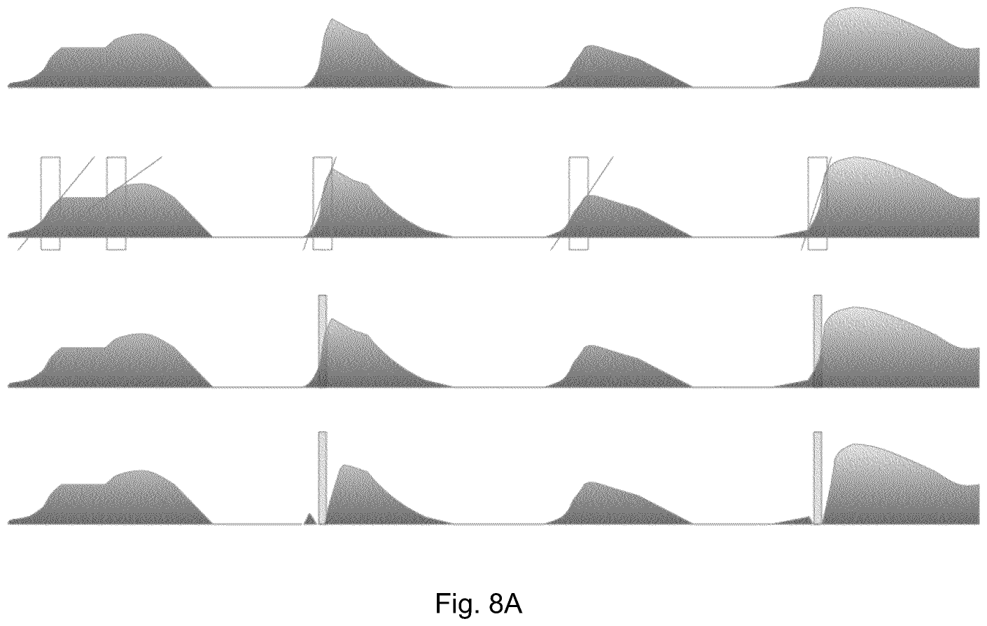

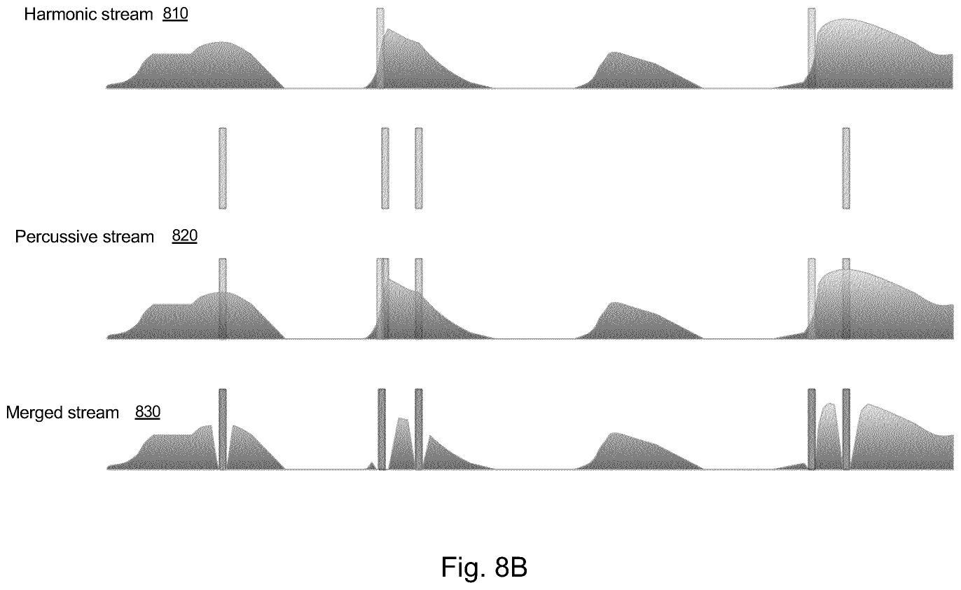

FIG. 8A illustrates the detection of the impulses in the impulse processing module using a gradient approach in an embodiment. The impulse processing module 204 calculates the rate of change of the audio signal to calculate the gradient or the slope for the percussive stream. The slope or the gradient is calculated at each point or at fixed intervals of time, for example, 100 microseconds. If the slope or the gradient is greater than a threshold value, then an impulse signal is generated. The threshold value is a slope greater than 60 degrees and less than 90 degrees. For example, if the gradient is greater than a 60 degree then the impulse processing module 204 may generate an impulse. Likewise, if the gradient is less than 60 degree angle then no impulse is generated as shown in FIG. 8A.

In addition, the gradient and duration of the impulse may be used to calculate the sharpness. The calculated sharpness value is provided to the comparator 570 to generate the array of time frequency values. In one variation of this implementation, the sharpness may be utilised for merging of the impulses obtained from the percussive spectrogram and the harmonic spectrogram. When the slope or the gradient lies between 50 degrees to 90 degrees, an impulse signal is generated.

FIG. 8B illustrates the detection of the impulses in the HPSS spectrogram using a gradient approach in another embodiment. The impulse may be determined separately for the harmonic spectrogram and the percussive spectrogram as shown in FIG. 8B. The gradient at different points of the harmonic spectrogram and the percussive spectrogram is calculated. When the impulses are detected either in the harmonic spectrogram or the percussive spectrogram, they are passed to the authoring tool 208. The harmonic stream 810 of the harmonic spectrogram and the percussive stream 820 of the percussive spectrogram are authored and a merged stream 830 of the impulses is produced. In one implementation, the impulses detected in the harmonic stream 810 and the percussive stream 820 are merged by a user through the authoring tool 208. Alternatively, the merging of the harmonic stream 810 and the percussive stream 820 is performed in real time by a based on a rule-based engine.

In another variation of this implementation, the merging of the harmonic stream 810 and the percussive stream 820 into a merged stream 830 is performed automatically using artificial intelligence processing module 216.

In yet another variation of this implementation, deep learning algorithms implemented in the artificial intelligence module 216 are utilized for merging the harmonic stream 810 and the percussive stream 820 into a merged stream 830. A training dataset of the harmonic stream 810 and the percussive stream 820 is provided for training the deep learning algorithms implemented in the artificial intelligence module 216.

In some embodiments, the gradient value is also used to calculate the sharpness of the signal from the impulse characteristics. The duration of impulse is used to determine the value of the sharpness. The sharpness value is used by the impulse processing module 204 for editing and/or merging the impulses.

In another embodiment , the harmonic stream 810 and the percussive stream 820 are processed separately in the impulse processing module 204 and then merged automatically using predefined algorithms. In some embodiments ,the process of merging the harmonic stream 810 and the percussive stream 820 involves suggesting the user through the user interface in the authoring tool 208 and providing the merged stream 830 to the user for editing/modification.

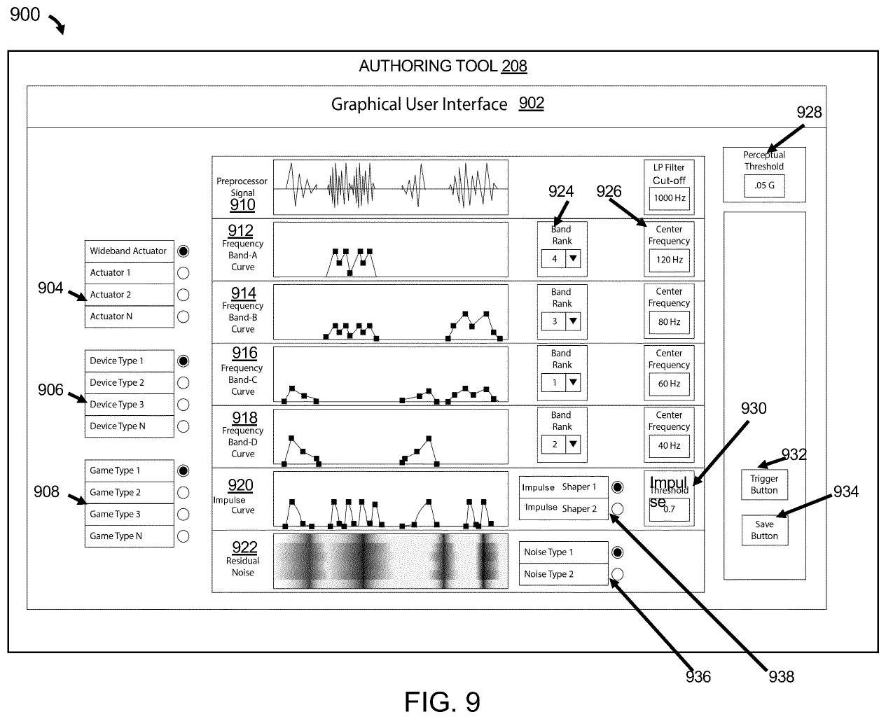

FIG. 9 illustrates a Graphical User Interface (GUI) of the authoring tool in an embodiment. The authoring tool 208 provides an exemplary GUI 902. The GUI 902 displays the audio preprocessed signal 910 as an audio waveform plot. The GUI 902 displays several signal curve editors for the array of time frequency values for each frequency band for the filter bank implementation of FIG. 4B.

Referring to GUI 902, a curve editor for a high frequency envelope 912, a curve editor for mid frequency envelopes 914 and 916, and a curve editor for a low frequency band envelope 918 is provided. Although, in this implementation only one high frequency band, two mid frequency bands, and one low frequency band are illustrated, in other implementations, there can be multiple frequency bands within the high frequency bands, the mid frequency bands, and the one low frequency band. The curve editors 912-918 display the time-amplitude envelopes having editable point for each time amplitude data values/point, which can be dragged by a mouse to either stretch or compress a time amplitude values/data point from the current time amplitude value to a new time amplitude value to change the characteristics of the haptic response. Since the time amplitude values/data points are already reduced in the breakpoint reduction module 470 or the breakpoint reduction module 514 and the breakpoint reduction module 524, therefore the curve editor allows easy manipulation of time amplitude values/data points. Additionally, time amplitude values/data points can be added or deleted to allow for further customization of the time amplitude envelope.

In addition, the GUI 902 also displays an impulse curve editor 920 and a residual spectrograph 922. The impulse curve editor 920 displays an impulse curve, which is provided by the impulse processing module 204. The impulse curve editor 920 allows editing and/or modification of the impulse sequence. In addition, the user can manipulate the merged stream 830 using the impulse curve editor 920. Additionally, the impulse curve editor 920 provides allows a user to drag the impulse curve with a mouse to reshape it.

The residual spectrogram comprises a residual noise editor 922 to adjust the noise component. Several noise shaping options are provided in the user interface through the noise type options 936 The noise type options 936 has selectable radio buttons, each radio button providing a specific type of noise shaping.

The GUI 902 also includes a number of combo boxes. Only three combo boxes are shown; however in other implementations there may be additional GUI components such as combo boxes or a dropdown box. In this implementation, a combo box 904 is used for selecting the actuator. Each actuator, such as actuators 122 or 126, has a unique actuator ID. The combo box 904 allows the user to select a specific actuator ID from the list of different types of actuators. Likewise, the combo box 906 allows the user to select the device ID associated with the actuators such as the actuator 122 or the actuator 126. In some embodiments, when the actuator 122 is embedded within the electronic computing device 102 the user may select a particular device ID, which would automatically fill the actuator ID president in the electronic computing device 102. The user may select the electronic computing device 102 from a list of devices such as a tablet, a joystick, a gamepad or a mobile phone through a selection of a radio button. Similarly, when a specific actuator ID is selected from the actuator combo box 904 then the device ID displays a list of devices that have the specific actuator embedded within it. In another implementation the contents of the actuator combo box 904 may be populated by querying the database 220. The combo box 908 is utilized for selecting the game type through a radio button. For example, the game type is divided based on the age and the content of the game such as fight game, racing game, adventure game or some other type of game.

The GUI 902 also includes an array of frequency rank drop-down menus 924 for selection of a frequency band rank. In addition, a center frequency text editor 926 is used to set the center frequency for each frequency band. For example, the high frequency band A curve 912 has a selection menu for selecting the frequency rank 924 and the center frequency 926 of the high frequency curve A. The values in the frequency band rank drop down menus 924 may range from 0 to the number of frequency bands received from the audio analysis module 206, with 0 being the default value of no preference for ranking, one (1) being the highest preference and the number of frequency bands received being the lowest preference. The default values of the center frequency text editor 926 are set by reading the center frequency value for each band received from the audio analysis module 206. The center frequency can be changed for entering new center frequency values for each frequency band.

Radio selection box 938 allows the user to select the shaping of the impulses from a list of impulse shapers, such as but not limited to impulse shape 1, impulse shaper 2, and others, in order to fine tune the experience of the impulses in the immersive haptic experience.

In some embodiments, the array of impulses generated by the harmonic spectrogram and the percussive spectrogram can be edited separately in the GUI and then merged either by deep learning algorithms. Alternatively, the array of impulses generated by the harmonic spectrogram and the percussive spectrogram can be merged using user intervention.

To shape haptic characteristics, the GUI 902 allows the user multiple options such as setting a perceptual threshold value through the perceptual text box 928, setting an impulse threshold value, which is a value that ranges from 0.0 to 1.0 by an impulse threshold text editor box 930.

The haptic trigger button 932 and save button 934 allow the customizations made by the user to each of the frequency bands of the analyzed array of time frequency values and/or the analyzed array of time amplitude values through the curve editors 912-918, the frequency band rank value through the frequency band rank drop down menu 924 and the center frequency value through the center frequency text editor 926 to be saved as an authored array of time frequency values, an authored array of time amplitude values and an authored array of time amplitude frequency values. In addition, customizations made by the user to an array of impulse sequence values through the impulse curve editor 920 and impulse score text box 930 are saved into an authored array of impulse sequence values. The authored the array of time amplitude values from the amplitude envelope module, and the authored array of impulse sequences from the impulse sequence of the percussive module 504; the authored array of time amplitude values from the amplitude envelope module and the authored array of time frequency values from the amplitude envelope associated with harmonic module 506; and the authored array of time amplitude frequency values associated with the residual module 508. In addition, the actuator ID value from the actuator combo box 904, the device ID value of the device selection combo box 906, and perceptual threshold value of the perceptual threshold text box 928 are saved in the database 220 and provided to the transformation module 208. Upon clicking either the save button 934, the data mentioned above is saved as an authored audio descriptor data and other authored data, which is passed to the transformation module 210 for further processing. A trigger button 928, captures an event, which is dispatched to the resynthesis module 214.

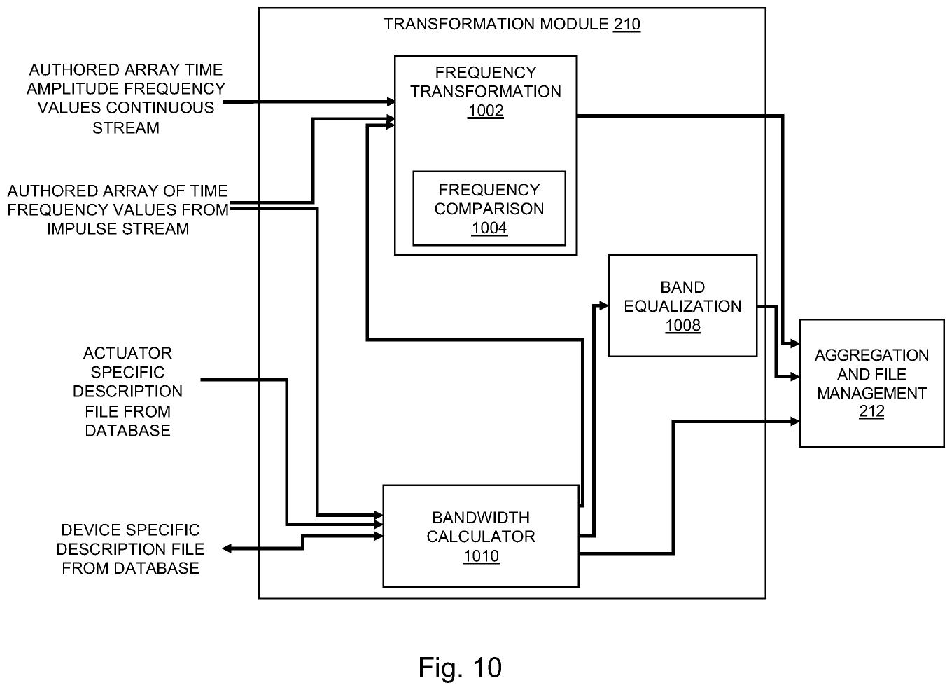

FIG. 10 illustrates a block diagram of a transformation module in the embodiment. The transformation module 210 transforms the authored array of time frequency values and the authored array of time amplitude values from the continuous stream and the authored array of time amplitude values comprising authored array of impulse sequence and the authored array of time frequency values from impulse stream to provide an immersive haptic experience for different combinations of actuators and devices.

When the haptic module 110 is implemented in the electronic computing device 102, the transformation module 210 utilizes the processor 114 and the memory 104. However, when the haptic module 300 resides in a distributed system 150 or network 302, the transformation module 210 has a processor 312 with the associated memory.

The transformation module 210 transforms the received the authored array of time frequency values and the authored array of time amplitude values from the continuous stream and the authored array of time amplitude values and the authored array of impulse sequence values to be adapted for a specific combination of the actuator 122 embedded within an electronic computing device 102. The transformation module 210 includes a frequency transformation 1002 comprising a frequency comparison 1004, a band equalization 1008, and a bandwidth calculator 1010.

The transformation module 210 receives the actuator specific description file and the device specific description file from the database module 220. As discussed, the database module 220 includes the actuator specific information 222 and the device specific information 224. The transformation module 210 queries the database module 220 utilizing the actuator ID and/or the device ID received from the authoring tool 208. In one example, the transformation module 210 sends a request to the database module 220 for querying the actuator specific information 222 and the device specific information 224 by passing the actuator ID and/or the device ID as parameters. The database module 220 extracts the relevant information from the database module 220 and provides the results to the transformation module 210.

The device specific information 224 can contain specification data or characteristic data such as the measured bandwidth, which is the acceleration over frequency response of specific actuators, such as the actuators 122 embedded within the electronic computing device 102 or the actuators 126 externally interfaced with the electronic computing device 102. In case the device specific information 224 contains no specification data or characteristic data of a specific actuator such as the actuator 122 embedded within the electronic computing device 102 and/or the actuators 126 associated with the electronic computing device 102, the bandwidth calculator 1010 determines the bandwidth of the electronic computing devices 102 with the embedded actuator 122. The bandwidth calculator 1010 calculates the bandwidth using specification data provided in the actuator specific information 222. The actuator specific information 222 includes mass of the actuator 122 or the actuator 126, mass of the actuator 122 or the actuator 126 with additional mass attached to it, the frequency response with and without additional attached mass. The bandwidth calculator 1010 determines the frequency response of the actuator 122 or the actuator 126 along with the electronic computing device 102. This combined bandwidth of the embedded actuator 122 within the electronic computing device is referred to as available bandwidth. To summarize, the available bandwidth is the range of frequencies at which the actuator such as the embedded actuator 122 and/or the associated actuator 126 and the electronic computing device 102 can create a vibration for an immersive haptic experience.

In addition, the bandwidth calculator 1010 determines the frequency and the amplitude response that can be experienced by humans. Humans can sense haptic vibrations above or below a specific threshold value within the available bandwidth of the electronic computing device 102 having embedded actuator 122. This threshold can be predefined to a constant, for example above 0.5 g acceleration, or can be specified with the perceptual threshold 928 in the GUI 902 of the authoring tool 208. For example, the combined bandwidth of the actuator 122 embedded in the electronic computing device 102 at which the human can feel vibration is referred to as “haptic perceptual bandwidth”. The haptic perceptual bandwidth lies in between the first threshold TH1, where the frequency response of the actuator 122 and the electronic computing device 102 curve just rises above a specific threshold value. This is the lower limit of the haptic perceptual bandwidth. Likewise, at another specific threshold value of the available bandwidth, the humans cannot feel the haptic experience. This threshold value is referred to as a second threshold TH2.

The haptic perceptual bandwidth, which lies between the first threshold TH1 and the second threshold TH2 is not fixed and can vary based on different parameters such as but not limited to individual experiences, specific thresholds to haptic vibrations at specific frequencies, specific sensitivity to haptic vibrations based on parts of the body, non-linear sensitivities to specific vibrations, and other parameters.

The haptic perceptual bandwidth calculated by the bandwidth calculator 1010 is provided to the frequency transformation 1002. In some embodiments, the haptic perceptual bandwidth calculated by the bandwidth calculator 1010 is stored in the database 220.

The frequency transformation 1002 includes a frequency comparison 1004, which checks if the center frequency of each of the frequency bands received from the authored array of time frequency values and the authored array of time amplitude values from the continuous stream and the authored array of time amplitude values and the authored array of time frequency values from the impulse stream can fit within the range of the haptic perceptual bandwidth. If all of the frequencies of the frequency bands fit within the range of the haptic perceptual bandwidth, then the authored array of time frequency values and the authored array of time amplitude values from the continuous stream and the array of authored time amplitude values and the authored array of time frequency values from the impulse stream is sent directly to the band equalization 1008. The band equalization 1008 increases or decreases the time amplitude values of the time amplitude envelope to compensate for the non-linear frequency and acceleration response curve of the actuator. For example, if a frequency that is far off from the resonant frequency has a lower acceleration force in g (gravity) then the amplitude values of the of the time amplitude envelope for this frequency is increased so that the actuator 122 creates a uniform acceleration compared to the resonant frequency when driven at that frequency.

However, if the frequency comparison 1008 evaluates that the authored array of time frequency values and the authored array of time amplitude values from the continuous stream and the authored array of time amplitude values and the authored array of time frequency values from the impulse stream cannot fit within the range of the haptic perceptual bandwidth, then the frequency comparison 1004 checks if the frequency band ranking has been provided. If the frequency band ranking has been provided, then the frequency comparison 1004 ranks the frequency bands in the order of the frequency band rankings. However, if no frequency band ranking is provided, the frequency transformation 1002 initiates a process of ranking the different frequency bands based on the envelope energy content. Each frequency band is ranked by determining the envelope energy content of that frequency band. The envelope energy is weighed against the distance of the energy content to the distance from the frequency of the highest acceleration in the haptic perceptual bandwidth. The frequency band with the highest acceleration value is set as the resonant frequency of the actuator 126 and the electronic computing device 102.

After determination of the frequency band ranking, the frequency transformation 1002 performs a frequency mapping process, which shifts the center frequency of each of the authored array time amplitude values and the authored array of time frequency values from continuous stream by a distance, which is equal to the difference in the highest frequency acceleration value in the haptic perceptual bandwidth of the electronic computing device 102 and the frequency of the highest rank band. As such, the frequency of the highest ranked band and the frequency with the highest acceleration value in the haptic perceptual bandwidth are aligned together or superimposed on each other. In preferred embodiments, the modulus value (positive value) of the difference is taken but in other embodiments the absolute value of the difference may be taken. Subsequently, the frequency comparison 1004 checks if all the frequency bands shifted can fit within the haptic perceptual bandwidth. If each of the frequency bands, which are shifted at its centre frequency, fit within the haptic perceptual bandwidth then the frequency transformation 1002 shifts all the frequency bands at the center frequency and passes the shifted frequency bands to the band equalization 1008 for further processing. However, if all the shifted frequency bands from the continuous stream do not fit within the haptic perceptual bandwidth then the frequency transformation 1002 performs harmonic shifting of all of the bands, except the highest ranked band. The center frequency of the highest ranked band remains unaltered whereas all the other frequencies are shifted by transposing up or transposing down with a fixed constant. The fixed constant value for transposing up/transposing down is based upon the direction of the original shifting of the frequency bands. The transposing up or transposing down can in one example be performed by transposing the frequencies by one octave up or down depending upon the direction of the original shifting of the frequency bands. After the shifting of the center frequency of each of the frequency bands by one octave up or one octave down, the frequency comparison 1004 determines if the frequency bands of the continuous stream can be shifted to fit within the haptic perceptual bandwidth. If so, the bandwidth calculator 1010 passes the authored array of time amplitude values and the authored array of time frequency values from the continuous stream to the band equalization 1008 for each frequency band for further processing. Otherwise, if the frequency bands of the authored array of time amplitude values and the authored array of time frequency values from continuous stream, which are shifted by one octave do not fit within the haptic perceptual bandwidth, then the frequency bands of the authored array of time amplitude values and the authored array of time frequency values from continuous stream that do not fit within the haptic perceptual bandwidth are removed and the remaining frequency bands are passed to the band equalization 1008.

The band equalization 1008 flattens and smoothes out the frequency response by boosting and/or dampening each of the frequency bands as required for haptic processing resynthesis.

The transformation module 208 passes an transformed continuous haptic stream and an transformed impulse haptic stream to the aggregation and file management module 212. In addition, the transformation module 208 also provides the haptic perceptual bandwidth to the aggregation and file management module 212.

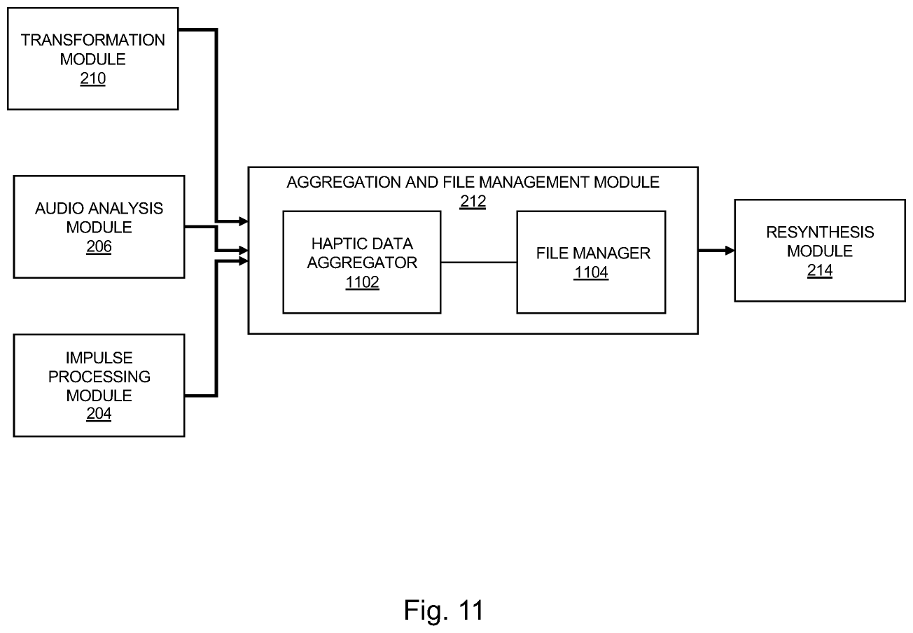

FIG. 11 illustrates the different components of the aggregation and file management module in an embodiment. The aggregation and file management module 212 comprises a haptic data aggregator 1102 and a file manager 1104. The haptic data aggregator 1102 receives the transformed continuous haptic stream and the transformed impulse haptic stream from the transformation module 210. In addition, the aggregation and file management module 212 also receives analyzed audio data from the audio analysis module 206. Furthermore, the aggregation and file management module 212 also receives input from the impulse processing module 204.

The file manager 1104 receives the haptic data from the haptic data aggregator 1102 and converts the transformed continuous haptic stream and the transformed impulse haptic stream and the other data from database 220 into multiple computer readable file format that can be processed and synthesized by the resynthesis module 214 for producing haptic output in one or more actuators like the actuator 122 or the actuator 126.

The file manager 1104 can convert the received data into different computer readable file formats for example, a text file, a JSON file, an XML, file, a CSV file, or some other file format.

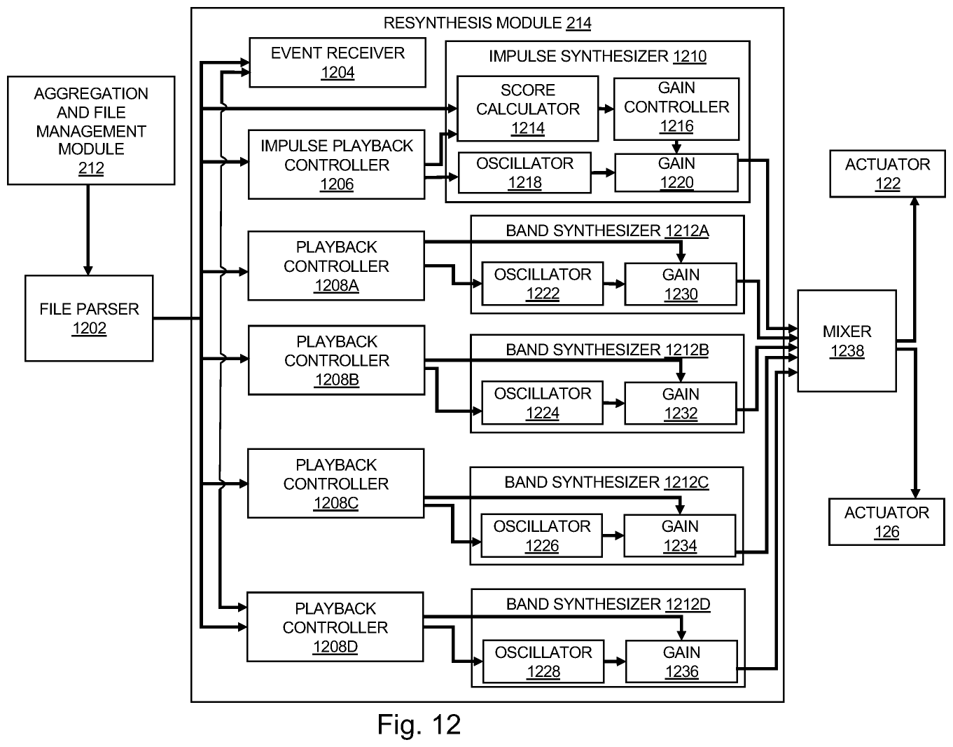

FIG. 12 illustrates the different modules of a resynthesis module in an embodiment. The purpose of the resynthesis module 214 is to generate a haptic signal by processing the computer readable file received from the aggregation and file management module 212 to drive an actuator, such as the actuator 122 or the actuator 126.

The resynthesis module 214 includes a file parser 1202, an event receiver 1204, an impulse playback controller 1206, an impulse synthesizer 1210, and one or more frequency playback controllers 1208.

In some embodiments, there may be one or more frequency playback controllers 1208, which may playback different frequencies. For example, as shown in FIG. 12, there are four playback controllers such as a playback controller 1208A, a playback controller 1208B, a playback controller 1208C, and a playback controller 1208D.

In some embodiments, there may be one or more frequency band synthesizers 1210. As shown in FIG. 12, there are four frequency band synthesizers such as a frequency band synthesizer 1212A, a frequency band synthesizer 1212B, a frequency band synthesizer 1212C a frequency band synthesizer 1212D.

The resynthesis module 214 includes a mixer 1238, which is configured to the actuator 122 and/or the actuator 126.

Although only four playback controllers 1208 and four frequency band synthesizers 1212 are shown in the exemplary embodiment, in other embodiments, there can be fewer or more number of playback controllers 1208 and the frequency band synthesizers 1212 depending upon the number of frequency bands.

In embodiments, the transformed array of time amplitude values and the transformed array of time frequency values from continuous stream and the transformed array of impulses and the transformed array time amplitude values from the impulse stream are processed and transformed to match the performance characteristics of the actuator 102 embedded in the electronic computing device 102.

In some embodiments, the transformed array time amplitude values and the transformed array of time frequency values from the continuous stream are used to synthesize different frequency bands and drive different playback controllers 1208A-1208D.

The impulse playback controller 1206 is connected to an impulse synthesizer 1210, which includes an impulse score calculator 1214, a gain controller 1216, an oscillator 1218 and a gain 1220. The sequence of impulses is received at the impulse playback controller 1206, which is passed to the impulse synthesizer 1210. The impulse synthesizer 1210 also receives an input from the event receiver 1204. In addition, the impulse synthesizer 1210 also receives input from the file parser 1202. The input received by the impulse synthesizer 1210 from other modules is passed to the binary score controller 1214. The binary score controller 1214 decides the triggering of impulse events. When the impulse event is triggered, the binary score calculator 1214 passes the amplitude values of the impulse(s) to the gain controller 1216 to control the gain 1220. Additionally, the gain 1220 also receives the frequency values of the impulses from the oscillator 1218 and passes it to the mixer 1238 to be passed to one or more actuators 122 or the actuators 126.

The playback controllers 1208A to 1208D receive the transformed array time frequency values and the transformed array of time amplitude values at the oscillators 1022-1028 for each frequency band. Simultaneously, the playback controllers 1008A-1008D pass the time amplitude values to the gain 1030-1036. The band synthesizer 1012A-1012D is passed to a mixer 1238, which mixes the output of different impulse synthesizer 1210 and the band synthesizers 1012A-1012D to be passed to one or more actuators 122 or the actuator 126 for providing the haptic output.

The traditional haptic configuration comprises a single actuator that receives the haptic signal and uses a mixer to mix separate signals to output a multiplexed haptic output. In some embodiments, the continuous stream and the impulse streams may be processed to produce separate haptic output to drive at least two separate actuators. For example, one actuator 122 can be a LRA that processes the impulse sequence. The other actuator 126 may be a wideband actuator processing the continuous stream. With two different actuators separately providing haptic output for the impulse stream and the continuous stream, the haptic experience of the user. Each actuator may be tuned to different frequencies thereby providing a wide range of haptic output. It may be noted that the resonant frequency of the actuator providing a continuous stream of haptic output may be different than the haptic actuator providing the impulse sequence.

In some embodiments, when implementing the filter banks technique, each frequency band is linked with the one playback controller 1208. For example, the playback controller 1208A is linked with the frequency band 60 Hz to 100 Hz. Likewise, the playback controller 1208D is linked with the frequency band 200 Hz to 300 Hz.

In embodiments, each actuator can receive its own mix of impulse and continuous signal. In some embodiments, the continuous stream of haptic output and the impulse stream of haptic output may be mixed in different proportions. In some embodiments, the mix proportion may be fixed. In some other embodiments, the mix proportion may be changed dynamically at runtime. In some embodiments, the mix proportion may be changed dynamically, which is controlled by the user interface of the authoring tool 208 or can be derived from the information stored in the database module 220 related to the actuator specific information 222 and/or the device specific information 224.

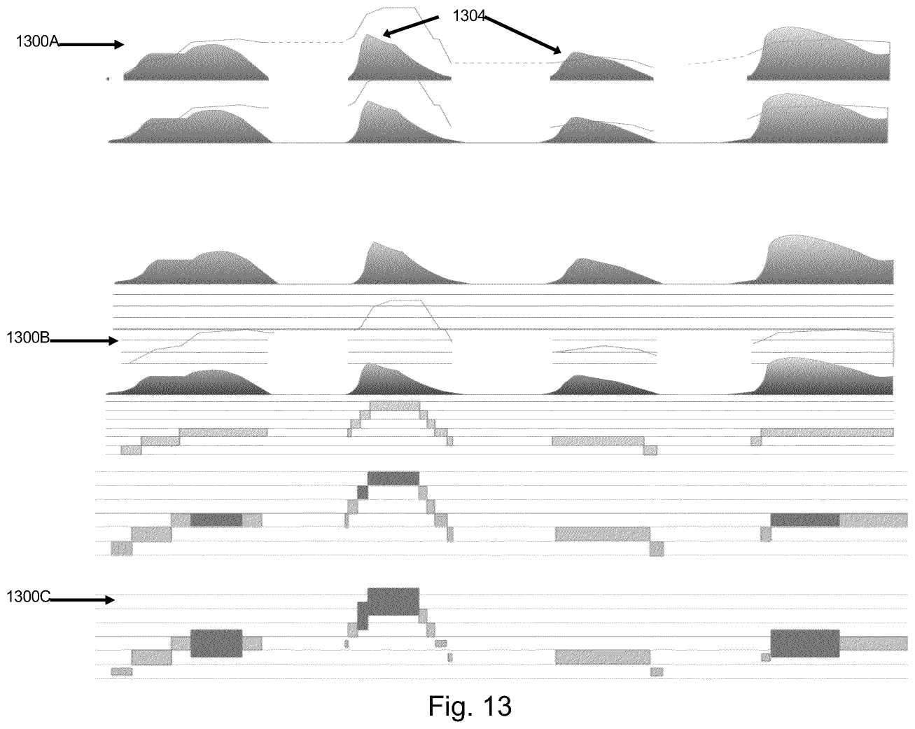

FIG. 13 illustrates the process of handling an audio signal having audio silence in an embodiment. A novel way of handling the audio silence in the audio Signal is disclosed. The audio signal is illustrated in 1300A. An audio silence is present between two audio snippets marked as 1304. The process of handling audio silence is initiated by interpolating the audio silence between two audio snippets. The interpolated audio signal is shown by 1304, which is a continuous audio signal after interpolation. In some embodiments, the interpolation can be performed by using the information envelope approximation and/or breakpoint analysis. At this step, the audio silence can be identified and accordingly identify the number of data points for generating the frequency envelope or the amplitude envelope. A In embodiments, the audio notes are construed as perceivable frequency differences.

As shown in FIG. 1300B, the audio notes are shown as discrete sections illustrating the frequency difference between adjacent notes. The discrete sections are combined by the user by combining the frequency and the amplitude to handle audio silence. This combination is illustrated in FIG. 1300C.

In some embodiments, the frequency line thickness is modulated by amplitude. In some embodiments, the frequency line color is modulated by amplitude. In some embodiments, the frequency discrete notes, which correspond to block height, are modulated by amplitude. In some embodiments, the frequency discrete notes block color (representing frequency difference) is modulated by amplitude.

In some embodiments, the frequency line thickness and frequency line color is modulated by amplitude.

In some embodiments, the frequency discrete notes are modulated by amplitude. In some embodiments, the frequency discrete notes may comprise block height or the block color.

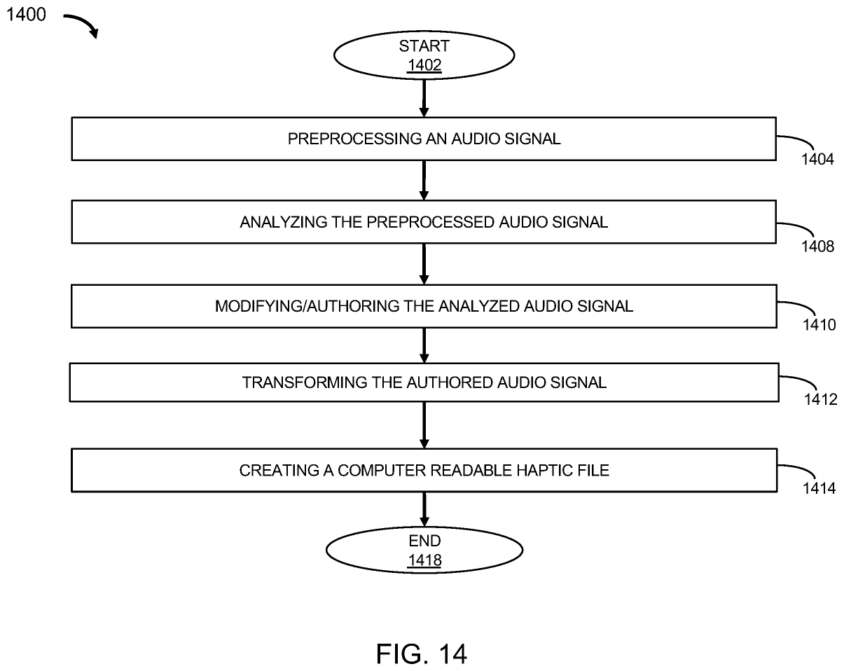

FIG. 14 illustrates a process of converting an audio signal into a computer readable haptic file in an embodiment. The process 1400 starts at 1402 and immediately moves to 1404. At step 1404, the audio signal is passed to an audio preprocessor 202. The preprocessor removes unwanted frequencies from the audio signal. The preprocessed audio signal is passed to an audio analysis module 206 at step 1408. At step 1408, the audio analysis module 206 performs the analysis of the preprocessed audio signal to convert it into a haptic signal. The audio analysis is performed by passing the preprocessed audio signal into a filter bank analysis or harmonic percussive source separation analysis for signal processing. In both these different processes, the spectral centroid of the signal is calculated. The output of the audio analysis is an analyzed audio signal, which is passed to the authoring tool 208 at step 1410. The analyzed audio signal is modified/edited in the authoring tool 208. The authoring tool 208 also receives the actuator specific information 222 and the device specific information 224 from the database module 220. The analyzed audio signal is at least modified based on the actuator specific information 222 and the device specific information 224. At step 1412 the authored audio signal is passed to the transformation module 210. The transformation module 210 applies a transformation algorithm to transform the authored audio signal to fit into the haptic perceptual bandwidth of the electronic computing device 102 and the actuator 122. The output of the transformation module 210 is a transformed audio signal. At step 1414, the transformed audio signal is passed to the aggregation and file management module 212 for converting the transformed audio signal into a computer readable haptic file. The process 1400 terminates at step 1418.

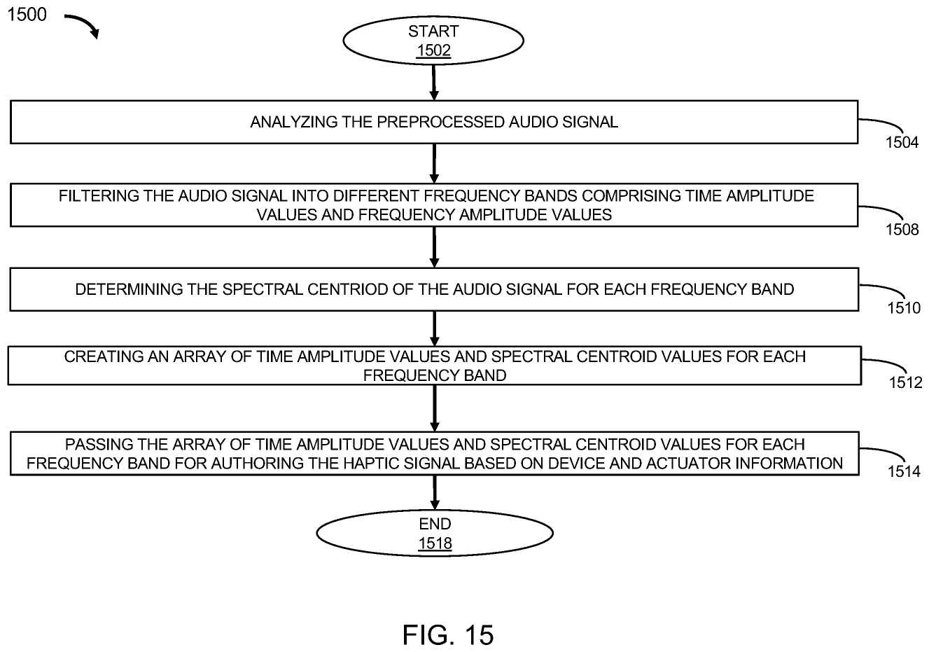

FIG. 15 illustrates a process of implementing a filter bank analysis to an audio signal in an embodiment. The process 1500 starts at 1502 and immediately moves to 1504. At step 1504, the preprocessed audio signal is received from the preprocessor module 202. The preprocessed audio signal is passed to an audio analysis module 206 at step 1508. At step 1508, the audio analysis module 208 filters the audio signal to separate the audio signal into one or more frequency bands. For each frequency band, the spectral centroid is calculated at step 1510. The process 1500, at step 1512 produces an array of spectral centroid, an array of time amplitude values, and an array of time frequency values for each frequency band. In one variation of this implementation, the transients are separated and an impulse sequence is created from the array of spectral centroid, the array of time amplitude values, and the array of time frequency values. At step 1514, the process 1500 passes the analyzed array of spectral centroid, the analyzed array of time amplitude values, and the analyzed array of time frequency values for each frequency band is passed to the authoring tool 208. The process 1500 for analyzing the preprocessed audio signal within the audio analysis module 206 terminates at step 1518.

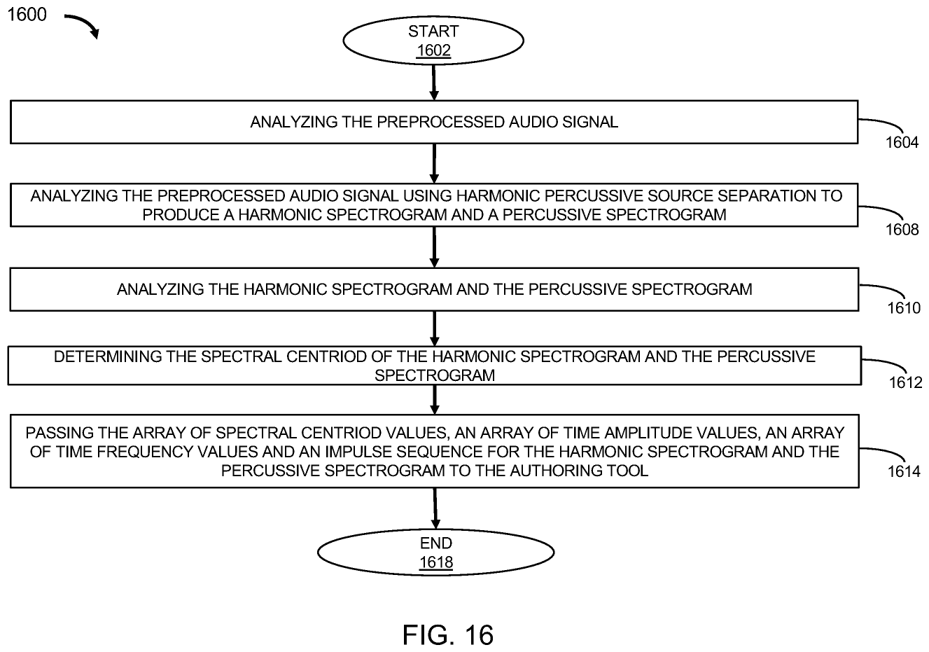

FIG. 16 illustrates a process of implementing a harmonic percussive source separation analysis to an audio signal in an embodiment. The process 1600 starts at 1602 and immediately moves to 1604. At step 1604, the preprocessed audio signal is received from the preprocessor module 202. The preprocessed audio signal is passed to an audio analysis module 206 at step 1608. At step 1608, the process 1600 analyzes the preprocessed audio signal using harmonic percussive source separation analysis to produce a harmonic spectrogram, a percussive spectrogram, and a residual spectrogram. In preferred embodiments, the residual spectrogram may be optional. At step 1610, the process 1600 analyzes the harmonic spectrogram and the percussive spectrogram. At step 1612, the process 1600 determines the spectral centroid of the harmonic spectrogram and the percussive spectrogram separately to create the array of frequency values and the array of impulse sequences for the percussive spectrogram and an array of time amplitude values and an array of time frequency values for the harmonic spectrogram. At step 1614, the process 1600 passes the array of spectral centriod values, an array of time amplitude values, an array of time frequency values and an impulse sequence to the authoring tool 208 for authoring the haptic content. The process 1600 terminates at step 1618.

The features, structures, or characteristics described throughout this specification may be combined in any suitable manner in one or more embodiments. The different embodiments and implementations shown herein and the illustrated example and for the purposes of providing what is believed to be the most useful and readily understood description of the principles and conceptual aspects in a non-limiting manner.

What is claimed is:

1. A computer implemented method of editing and transforming an audio signal into a haptic data to provide immersive haptic experience, the computer implemented method comprising:
receiving the audio signal at a preprocessor to determine a peak to peak amplitude of the audio signal for a frame having a fixed number of a sampled audio data;
taking a Fast Fourier Transform to derive the frequency distribution of the audio signal;
calculating the weighted average mean of the derived frequency distribution to derive a spectral centroid of the sampled audio data;
replacing a predefined number of sampled audio data with a new sampled audio data and calculating a new spectral centroid of the audio signal to produce an array of the spectral centroid;
providing the array of the spectral centroid in a user interface to modify the array of spectral centroid for the immersive haptic experience, and
creating a computer readable file to provide an immersive haptic experience.

2. The computer implemented method of claim 1, wherein the array of the spectral centroid values comprising an array of time amplitude values and an array of time frequency values are modified using a user interface.

3. The computer implemented method of claim 1, wherein the modification of the array of spectral centroid values is based on a device specific information and an actuator specific information.

4. The computer implemented method of claim 1, wherein the device specific information includes device mass, device type, device operating characteristics and actuator specific characteristics embedded in the device.

5. The computer implemented method of claim 1, wherein the spectral centroid is calculated by adding the sum of the spectral energy of each frequency multiplied by the average value of each frequency band over the sum of spectral energy for all the frequency bands.

6. A computer implemented method of authoring and transforming an audio signal into a haptic output to provide immersive haptic experience, the computer implemented method comprising:
receiving the audio signal at a preprocessor for a fixed number of audio samples;
applying harmonic percussive source separation to pre-processed fixed number of audio samples, wherein the harmonic percussive source separation comprises a harmonic spectrogram and a percussive spectrogram;
calculating an array of time amplitude values and an array of time frequency values for the harmonic spectrogram and the percussive spectrogram;
calculating an array of spectral centroid of the harmonic spectrogram and the percussive spectrogram;
providing the array of the spectral centroid, the array of time amplitude values and the array of time frequency values to a user interface to modify at least one of the array of values of the harmonic spectrogram and the percussive spectrogram;
transforming authored array of spectral centroid, the array of time amplitude values and the array of time frequency values to fit into a haptic perceptual bandwidth, and
creating a computer readable file.

7. The computer implemented method of claim 6, wherein the harmonic percussive source separation further includes a residual spectrogram, which is obtained by subtracting the harmonic spectrogram and the percussive spectrogram from the transformed harmonic percussive source separation spectrogram.

8. The computer implemented method of claim 6, wherein the transformation of the authored array of spectral centroid, the array of time amplitude values and the array of time frequency values is based at least on a device specific information and an actuator specific information.

9. The computer implemented method of claim 6, wherein each spectral centroid for the harmonic component and the percussive component is calculated by adding the sum of the spectral energy multiplied by the average value of each frequency band over the sum of spectral energy of all the frequency bands.

10. A haptic authoring system for converting an audio signal into a computer readable haptic file, the computer readable file when executed by a processor causes the haptic authoring system to produce an immersive haptic experience on the associated electronic computing device, the haptic authoring system comprising:
a preprocessor module configured to an audio analysis module, wherein the audio analysis module receives a preprocessed audio signal and converts the preprocessed audio signal into an array of time amplitude values and an array of time frequency values, and wherein the audio analysis module calculates the spectral centroid of the array of time frequency values;
an user interface for modifying the array of time amplitude values, the array of time frequency values and the array of time frequency values;
a transformation module for transforming an authored array of time amplitude values, an authored array of time frequency values and an authored array of time frequency values to fit into a haptic perceptual bandwidth, and
an aggregation and file management module for converting an array of transformed time amplitude values, an array of transformed time frequency values and an array of transformed time frequency values into the computer readable haptic file.

11. The haptic authoring system of claim 10, wherein the spectral centroid is calculated by adding the sum of the spectral energy of each frequency multiplied by the average value of each frequency band over the sum of spectral energy for all the frequency bands.

12. The haptic authoring system of claim 10, the transformation module transforms the harmonic spectrogram and the percussive spectrogram based at least on a device specific information includes device mass, device type, device operating characteristics and an actuator specific characteristics embedded in the device.

13. A haptic authoring system for converting an audio signal into a computer readable haptic file, the computer readable file when executed by a processor causes the haptic authoring system to produce an immersive haptic experience on the associated electronic computing device, the haptic authoring system comprising:
a preprocessor module configured to an audio analysis module, wherein the audio analysis module receives a preprocessed audio signal and applies a harmonic percussive source separation to the preprocessed audio signal to determine a harmonic spectrogram and a percussive spectrogram, and wherein the audio analysis module calculates the spectral centroid of the harmonic spectrogram and the percussive spectrogram;
an user interface for modifying the harmonic spectrogram and the percussive spectrogram, wherein the harmonic spectrogram comprises an array of time amplitude values and an array of time frequency values and the percussive spectrogram comprises an array of time frequency values and an array of impulse sequence;
a transformation module for transforming an authored harmonic spectrogram and an authored percussive spectrogram to fit into a haptic perceptual bandwidth, and an aggregation and file management module for converting a transformed harmonic spectrogram and a transformed percussive spectrogram into the computer readable haptic file.

14. The haptic authoring system of claim 13, wherein the spectral centroid is calculated by adding the sum of the spectral energy of each frequency multiplied by the average value of each frequency band over the sum of spectral energy for all the frequency bands.

15. The haptic authoring system of claim 13, the transformation module transforms the harmonic spectrogram and the percussive spectrogram based at least on a device specific information includes device mass, device type, device operating characteristics and an actuator specific characteristics embedded in the device.
